(19) United States
(12) Patent Application Publication
(10) Pub. No.: US 2024/0343616 A1
(43) Pub. Date: Oct. 17, 2024

(54) ADSORPTION DESALINATION DIRECT CONTACT MEMBRANE DISTILLATION SYSTEM

(71) Applicant: KING FAHD UNIVERSITY OF PETROLEUM AND MINERALS, Dhahran (SA)

(72) Inventors: Ayman Abdulhak Ahmed Ibrahim ALAZAB, Dhahran (SA); Naef Abduljalil Abdulrahman QASEM, Dhahran (SA); Hassan Mohammed BAAQEEL, Dhahran (SA)

(73) Assignee: KING FAHD UNIVERSITY OF PETROLEUM AND MINERALS, Dhahran (SA)

(21) Appl. No.: 18/298,533

(22) Filed: Apr. 11, 2023

(51) Int. Cl. C02F 1/44; B01D 61/36; C02F 1/28; C02F 103/08

(52) U.S. Cl. CPC C02F 1/447; B01D 61/3641; C02F 1/28; B01D 61/368; B01D 2311/2626; B01D 2311/2673; B01D 2311/2674; B01D 2313/22; B01D 2313/243; B01D 2313/501; B01D 2313/502; B01D 2313/90; B01D 2315/10; B01D 2315/24; B01D 2317/025; B01D 2317/04; C02F 2103/08; C02F 2201/005; C02F 2201/007

(57) ABSTRACT

The present disclosure relates to a hybrid AD-DCMD desalination system, where two subsystems, such as AD and DCMD, are integrated synergistically to maximize freshwater production. The waste heat released from an AD condenser is used to drive the DCMD subsystem in a first configuration of the hybrid AD-DCMD system, while another configuration relies on the heat released due to an exothermic adsorption process in an adsorption bed. The DCMD subsystem is included to exploit the waste heat of the AD subsystem to enhance performance. In both these configurations, seawater is used to release the heat from the AD subsystem, which is then fed into the DCMD subsystem. The hybrid AD-DCMD system configurations demonstrate improved performance in terms of GOR, specific daily water production (SDWP), and freshwater cost reduction.

### STATEMENT REGARDING PRIOR DISCLOSURE BY THE INVENTORS

The present disclosure was described in an article “Performance evaluation of a novel integrated adsorption desalination system with direct contact membrane distillation plant” published in SSRN on Nov. 1, 2022, which is incorporated as reference herein in its entirety. [See: A. A. Alazab, N. A. A. Qasem, H. Baaqeel, Performance evaluation of a novel integrated adsorption desalination system with direct contact membrane distillation plant, Desalination. 552 (2023) 116441. https://doi.org/10.1016/J.DESAL.2023.116441]

### STATEMENT OF ACKNOWLEDGEMENT

The support provided by the King Fahd University of Petroleum & Minerals (KFUPM), Riyadh, Saudi Arabia through Project INRE2213 is gratefully acknowledged.

### BACKGROUND

### Technical Field

The present disclosure relates to a production of freshwater from aqueous solution, such as brine water, and more particularly relates to the production of freshwater through membrane distillation.

### Discussion of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Many water-stressed or arid regions or countries are augmenting their water supply with desalinated water to meet an increased water demand caused by growth which is triggered by increased population, industrial expansion, tourism, and agriculture development. Desalination has provided a reliable and sustainable source of freshwater to the growing populations and economies in, for example, the Arabian Gulf region. In fact, countries in the Arabian Gulf produce approximately 40% of the world's desalinated water. Some of these countries rely on desalination for more than 90% of their drinking water and, hence, desalination has been a critical component of sustaining life and economic vitality in such regions. Currently, 50% of the world's desalination capacity is based on membranes employing the reverse osmosis (RO) concept, with the remainder coming from thermal processes including multi-stage flashing (MSF), multi-effect desalination (MED), vapor compression (VC), membrane distillation (MD), and adsorption desalination (AD). Arab Gulf Cooperation Council (GCC) countries are predominantly adopting thermal-based (non-membrane) desalination technologies. One of the primary reasons for use of thermal methods in the GCC countries is the low water recovery ratio of the RO process due to the Gulfs high feed salinity and membrane fouling susceptibility at high brine concentrations. Another reason is the toxins in seawater feed, which result from the frequent occurrence of harmful algae blooms (HABs) in the water of the Arabian Gulf, which can pass through the membrane pores and cause human illnesses and death if they are ingested.

Although significant improvements have taken place in thermal desalination technology, a widespread use of the same is currently limited to energy-rich countries due to the high energy requirements of such technologies, which require enormous volumes of water throughput. These energy requirements are currently supplied by burning fossil fuels in power plants or boiler plants, which significantly contributes to global warming and releases toxic brine into the oceans. Hence, engineers and scientists have searched for alternate technologies that are either more energy efficient or employ waste and lower-grade heat sources in order to fulfill the increasing demand for desalinated water. The AD and MD are two of such developed methods. In comparison to more traditional methods like RO, MSF, and MED, which work at high temperatures or pressures, AD and MD are capable of operating at lower temperatures and pressures. Moreover, the key advantages of these newer technologies are their ease of use, compactness, and ability to handle variable loads (intermittent energy supply) without the need for extra operating changes.

In the last decade, AD desalination has emerged as a promising heat-driven adsorption/desorption cycle for desalination. In the AD desalination, an adsorbent (e.g., silica gel) is employed to adsorb the vapor supplied from an evaporator at low pressure and temperature. Due to a double-bond surface forces that exist between a mesoporous absorbent (e.g., silica gel) and an adsorbate (water vapor), the vapor from the evaporator is adsorbed under a low-pressure environment. Adsorbent pore sizes range from 10 nm to 40 nm, with an average pore surface area of 600-800 m²/g. An adsorbent, such as silica gel, has many advantages, the most important of which is its high uptake of water vapor and its capability to be regenerated by a low-temperature heat source (for desorption), typically from 55° C. to 85° C. Unlike other thermally driven processes, raw seawater is delivered to the evaporator without a heating or pressurization process. Once the adsorbent is saturated, it is heated to release the water vapor prior to flowing to an external condenser for condensation. Silica gel is widely available at a low cost and can be used in beds of various geometries, such as vertical silos, minimizing the footprint, especially for large-scale.

The AD process consists of two half-cycles (interval times range from 200 s to 700 s). During the half-cycle times of batch-operated operations, valves are used to connect reactor beds to either a condenser or the evaporator. A switching interval of 20 s to 40 s is used to either preheat or cool the exchangers. In addition to being energy efficient, the AD process has almost no moving parts, which ensures that it is extremely low maintenance by design.

MD is known as an emerging thermally driven method of separation that only transports water vapor through a hydrophobic, microporous membrane. A partial vapor pressure difference maintained at the membrane's two interfaces (hot feed and cold permeate sides) serves as the driving force for MD's operation [M. S. Khayet, T. Matsuura, Membrane distillation: principles and applications, (2011) 477]. Like in the AD process, a key advantage of the MD process is that high feed salinity has a negligible impact on the process performance.

Based on the condition applied on the cold permeate side of the membrane, different MD configurations are known. For example, direct contact membrane distillation (DCMD), vacuum membrane distillation (VMD), air gap membrane distillation (AGMD), and sweeping gas membrane distillation (SGMD), whose cold permeate sides include cooling water, vacuum, cold plate for stagnant air, and inert gas, respectively. Other MD configurations, such as, liquid-gap MD and material-gap MD, have been recently developed for the purpose of improving permeate flux.

DCMD is known for its efficiency in removing non-volatile compounds. The DCMD is not limited to the purification of water and may also be used to treat extremely high concentrations of organic contaminants, such as oilfield-produced water. Additionally, DCMD is also known for its use in the concentration of aqueous solutions in the food industry or in the production of acids.

However, the performance of the AD system (as a standalone system) is subpar and needs improvements. It is also worth noting that the DCMD may be operated at low temperatures (40° C. to 90° C.) with high flux and 100% salt rejection and, therefore, may be operated by waste heat from the AD process.

Accordingly, it is one object of the present disclosure to provide a hybrid system that involves integration of the AD process and the DCMD process.

### SUMMARY

In an exemplary embodiment, an adsorption desalination direct contact membrane distillation (AD-DCMD) system is provided. The AD-DCMD system includes a DCMD module having a hot compartment, a cold compartment, and a membrane separating the hot compartment and the cold compartment. The membrane is configured to permit water vapor to pass from a saltwater feed compartment to a water compartment. The water compartment includes a DCMD condenser to condense the water vapor passing through the membrane. The AD-DCMD system further includes a seawater tank that is in fluid communication with (a) a condenser and configured to pass a seawater stream to the condenser via a seawater pump, and (b) an evaporator and configured to pass the seawater stream to the evaporator via the seawater pump. The condenser is in fluid communication with (a) an adsorber and configured to pass a heated condensed seawater stream to the adsorber via a second valve, (b) the hot compartment of the DCMD module and configured to pass the heated condensed seawater stream to the hot compartment, and (c) a desorber and configured to pass a heated desorbed seawater stream to the desorber via a fourth valve. The AD-DCMD system further includes a hot water tank in fluid communication with the desorber and configured to heat the heated desorbed water stream leaving a desorber outlet and return the heated desorbed water stream leaving the desorber outlet to the desorber through a desorber inlet. The adsorber is in fluid communication with the evaporator and configured to pass a cooled evaporated seawater stream to the evaporator via a first valve. The desorber is in fluid communication with the evaporator and configured to pass a cooled evaporated seawater stream to the evaporator via a third valve. The evaporator is in fluid communication with a brine tank and configured to pass a brine stream to the brine tank. The condenser is in fluid communication with a freshwater tank and configured to pass a freshwater stream to the freshwater tank. The cold compartment of the DCMD module is in fluid communication with a coolant tank and configured to pass a separated freshwater stream to the coolant tank, and the coolant tank is configured to return a separated saltwater stream to the cold compartment. The coolant tank is in fluid communication with the freshwater tank and configured to pass the separated freshwater stream to the freshwater tank. The hot compartment of the DCMD module is in fluid communication with the brine tank by passing a separated brine stream to the brine tank.

In some embodiments, the adsorber and the desorber are housed conjoined within the same housing. In some embodiments, the adsorber, the desorber, the condenser, and the evaporator are all housed within the same housing.

In some embodiments, the seawater tank is in direct fluid communication with the adsorber and the evaporator, and the seawater tank is configured to pass the seawater stream to the adsorber and the evaporator respectively.

In some embodiments, the adsorber is in direct fluid communication with the hot compartment of the DCMD module and configured to pass an adsorber stream to the hot compartment.

In some embodiments, the AD-DCMD system includes 5 to 25 DCMD modules. In some embodiments, the DCMD modules are arranged in a counter-current configuration.

In some embodiments, the DCMD modules are arranged in a parallel/cross flow configuration.

In some embodiments, a first DCMD module outlet of a first DCMD module is in fluid communication with a second DCMD module inlet of a second DCMD module and configured to pass a DCMD stream from the first DCMD module outlet to the second DCMD module inlet.

In some embodiments, the first DCMD module outlet and the second DCMD module are disposed at the same height relative to a first membrane in the first DCMD module and a second membrane in the second DCMD module, respectively.

In some embodiments, the first DCMD module is in fluid communication with the coolant tank and configured to pass a coolant tank stream from the coolant tank to the first DCMD module through a first DCMD module inlet.

In some embodiments, a terminal DCMD module is in fluid communication with the coolant tank and configured to return a terminal DCMD stream from the terminal DCMD module to the coolant tank through a terminal DCMD module outlet.

In some embodiments, the seawater pump is configured to pump a portion of the seawater stream to both the condenser and the evaporator. In some embodiments, the seawater pump is configured to pump a portion of the seawater stream to both the adsorber and the evaporator. In some embodiments, the seawater pump is an axial flow pump.

In some embodiments, the membrane separating the hot compartment and the cold compartment is at least one selected from the group consisting of a composite membrane, a nano-composite membrane, a hydrophobic membrane, an omniphobic membrane, a hydrophilic and hydrophobic composite dual layer membrane, a modified ceramic membrane, a porous ceramic membrane, a surface modified membrane, a polymer electrolyte membrane, a porous graphene membrane, and a polymeric membrane.

In some embodiments, the first valve, the second valve, the third valve, and the fourth valve are gate valves. In some embodiments, the first valve and the fourth valve are parallel disc gate valves. In some embodiments, the second valve and the third valve are solid-wedge gate valves.

These and other aspects of non-limiting embodiments of the present disclosure will become apparent to those skilled in the art upon review of the following description of specific non-limiting embodiments of the disclosure in conjunction with the accompanying drawings.

### BRIEF DESCRIPTION OF THE DRAWINGS

A better understanding of embodiments of the present disclosure (including alternatives and/or variations thereof) may be obtained with reference to the detailed description of the embodiments along with the following drawings, in which:

FIG. 1 illustrates a first exemplary configuration of an adsorption desalination direct contact membrane distillation (AD-DCMD) system, according to an aspect of the present disclosure;

FIG. 2 illustrates a second exemplary configuration of the AD-DCMD system, according to an aspect of the present disclosure;

FIG. 3A illustrates a graphical comparison of model and experimental values of heat released by a DCMD module of the AD-DCMD system at various inlet feed temperatures, according to an aspect of the present disclosure;

FIG. 3B illustrates a graphical comparison of model and experimental values of energy efficiency of the DCMD module of the AD-DCMD system at various inlet feed temperatures, according to an aspect of the present disclosure;

FIG. 3C illustrates a graphical comparison of model and experimental values of coefficient of performance of an AD module of the AD-DCMD system at various average hot water inlet temperature, according to an aspect of the present disclosure;

FIG. 3D illustrates a graphical comparison of model and experimental values of specific daily water production (SDWP) of an AD module of the AD-DCMD system at various average hot water inlet temperature, according to an aspect of the present disclosure;

FIG. 4 illustrates a graph of temperature profiles of components of the AD module corresponding to the first exemplary configuration of the AD-DCMD system, according to an aspect of the present disclosure;

FIG. 5 is a graph illustrating an effect of half cycle time on gained output ratio (GOR) values for the first exemplary configuration of the AD-DCMD system, according to an aspect of the present disclosure;

FIG. 6A is a graph illustrating an effect of mass flow rate of inlet seawater to a condenser on the freshwater production at different heating water flow rates for the whole AD-DCMD system, according to an aspect of the present disclosure;

FIG. 6B is a graph illustrating an effect of mass flow rate of inlet seawater to the condenser on the freshwater production at different heating water flow rates for the AD module of the AD-DCMD system, according to an aspect of the present disclosure;

FIG. 6C is a graph illustrating an effect of mass flow rate of inlet seawater to the condenser on the freshwater production at different heating water flow rates for the DCMD module of the AD-DCMD system, according to an aspect of the present disclosure;

FIG. 7A is a graph illustrating an effect of mass flow rate of inlet seawater to the condenser on the GOR at different heating water flow rates for the whole AD-DCMD system, according to an aspect of the present disclosure;

FIG. 7B is a graph illustrating an effect of mass flow rate of inlet seawater to the condenser on the GOR at different heating water flow rates for the AD module of the AD-DCMD system, according to an aspect of the present disclosure;

FIG. 7C is a graph illustrating an effect of mass flow rate of inlet seawater to the condenser on the GOR at different heating water flow rates for the DCMD module of the AD-DCMD system, according to an aspect of the present disclosure;

FIG. 8A is a graph illustrating an effect of temperature of inlet seawater to the condenser on the freshwater production at different heating water flow rates for the whole AD-DCMD system, according to an aspect of the present disclosure;

FIG. 8B is a graph illustrating an effect of temperature of inlet seawater to the condenser on the freshwater production at different heating water flow rates for the AD module of the AD-DCMD system, according to an aspect of the present disclosure;

FIG. 8C is a graph illustrating an effect of temperature of inlet seawater to the condenser on the freshwater production at different heating water flow rates for the DCMD module of the AD-DCMD system, according to an aspect of the present disclosure;

FIG. 9A is a graph illustrating an effect of temperature of inlet seawater to the condenser on the GOR at different heating water flow rates for the whole AD-DCMD system, according to an aspect of the present disclosure;

FIG. 9B is a graph illustrating an effect of temperature of inlet seawater to the condenser on the GOR at different heating water flow rates for the AD module of the AD-DCMD system, according to an aspect of the present disclosure;

FIG. 9C is a graph illustrating an effect of temperature of inlet seawater to the condenser on the GOR at different heating water flow rates for the DCMD module of the AD-DCMD system, according to an aspect of the present disclosure;

FIG. 10A is a graph illustrating an effect of mass flowrate of inlet seawater (cooling water and feed water) for the DCMD module on the freshwater production at different heating water flow rates for the whole AD-DCMD system, according to an aspect of the present disclosure;

FIG. 10B is a graph illustrating an effect of mass flowrate of inlet seawater (cooling water and feed water) for the DCMD module on the freshwater production at different heating water flow rates for the AD module of the AD-DCMD system, according to an aspect of the present disclosure;

FIG. 10C is a graph illustrating an effect of mass flowrate of inlet seawater (cooling water and feed water) for the DCMD module on the freshwater production at different heating water flow rates for the DCMD module of the AD-DCMD system, according to an aspect of the present disclosure;

FIG. 11A is a graph illustrating an effect of mass flowrate of inlet seawater (cooling water and feed water) for the DCMD module on the GOR at different heating water flow rates for the whole AD-DCMD system, according to an aspect of the present disclosure;

FIG. 11B is a graph illustrating an effect of mass flowrate of inlet seawater (cooling water and feed water) for the DCMD module on the GOR at different heating water flow rates for the AD module of the AD-DCMD system, according to an aspect of the present disclosure;

FIG. 11C is a graph illustrating an effect of mass flowrate of inlet seawater (cooling water and feed water) for the DCMD module on the GOR at different heating water flow rates for the DCMD module of the AD-DCMD system, according to an aspect of the present disclosure;

FIG. 12A is a graph illustrating an effect of temperature of inlet seawater (cooling water and feed water) for the DCMD module on the freshwater production at different heating water temperatures for the whole AD-DCMD system, according to an aspect of the present disclosure;

FIG. 12B is a graph illustrating an effect of temperature of inlet seawater (cooling water and feed water) for the DCMD module on the freshwater production at different heating water temperatures for the AD module of the AD-DCMD system, according to an aspect of the present disclosure;

FIG. 12C is a graph illustrating an effect of temperature of inlet seawater (cooling water and feed water) for the DCMD module on the freshwater production at different heating water temperatures for the DCMD module of the AD-DCMD system, according to an aspect of the present disclosure;

FIG. 13A is a graph illustrating an effect of temperature of inlet seawater (cooling water and feed water) for the DCMD module on the GOR at different heating water temperatures for the whole AD-DCMD system, according to an aspect of the present disclosure;

FIG. 13B is a graph illustrating an effect of temperature of inlet seawater (cooling water and feed water) for the DCMD module on the GOR at different heating water temperatures for the AD module of the AD-DCMD system, according to an aspect of the present disclosure;

FIG. 13C is a graph illustrating an effect of temperature of inlet seawater (cooling water and feed water) for the DCMD module on the GOR at different heating water temperatures for the DCMD module of the AD-DCMD system, according to an aspect of the present disclosure;

FIG. 14 is a graph illustrating SDWP of the first and the second configurations of the AD-DCMD system at different heat source temperatures, according to an aspect of the present disclosure;

FIG. 15 is a graph illustrating COP of the first and the second configurations of the AD-DCMD system at different heat source temperatures, according to an aspect of the present disclosure; and

FIG. 16 is a graph illustrating freshwater costs of the first and the second configurations of the AD-DCMD system at different heat source temperatures, according to an aspect of the present disclosure.

### DETAILED DESCRIPTION

In the following description, it is understood that other embodiments may be utilized, and structural and operational changes may be made without departure from the scope of the present embodiments disclosed herein.

Reference will now be made in detail to specific embodiments or features, examples of which are illustrated in the accompanying drawings. Wherever possible, corresponding, or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to adsorption desalination direct contact membrane distillation (AD-DCMD) system which is a hybrid system resulting from an integration of the AD and DCMS subsystems. The two subsystems are integrated synergistically to maximize gained output ratio (GOR) and freshwater production and minimize freshwater cost. The waste heat released from an AD condenser is used to drive the DCMD subsystem in a first configuration of the hybrid AD-DCMD system, while another configuration relies on the heat released due to an exothermic adsorption process in an adsorption bed. The DCMD subsystem is included to exploit the waste heat of the AD subsystem to enhance performance. In both these configurations, seawater is used to release the heat from the AD subsystem, which is then fed into the DCMD subsystem. The hybrid AD-DCMD system configurations demonstrate improved performance in terms of GOR, specific daily water production (SDWP), and freshwater cost reduction. In addition, both configurations produce a cooling effect as a by-product.

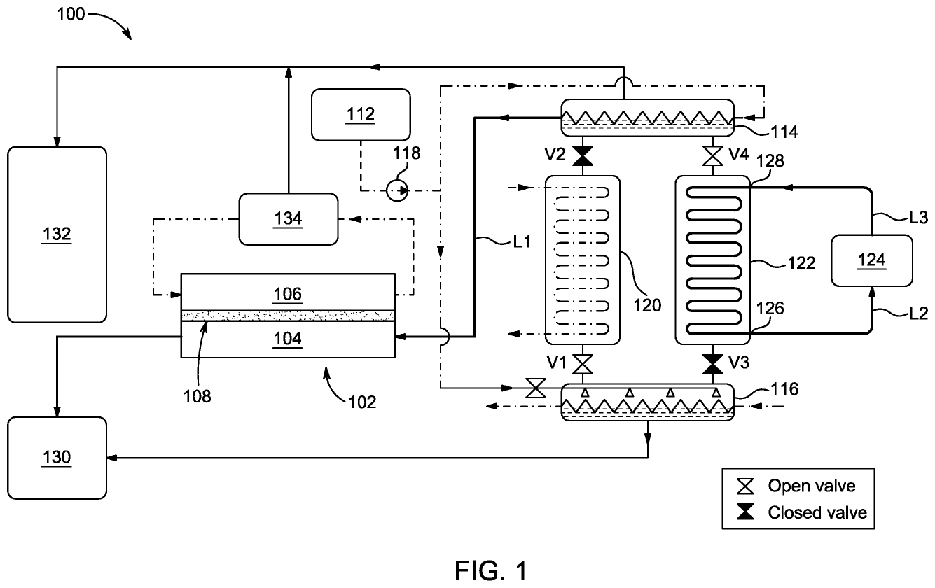

FIG. 1 illustrates a first exemplary configuration of an adsorption desalination direct contact membrane distillation (AD-DCMD) system 100 (hereinafter referred to as “the system 100”), according to an embodiment of the present disclosure. The system 100 includes a DCMD module 102 having a hot compartment 104, a cold compartment 106, and a membrane 108 that separates the hot compartment 104 from the cold compartment 106. The membrane 108 is configured to permit water vapor to pass from the hot compartment 104 to the cold compartment 106. In some embodiments, the membrane 108 is at least one selected from the group consisting of a composite membrane, a nano-composite membrane, a hydrophobic membrane, an omniphobic membrane, a hydrophilic and hydrophobic composite dual layer membrane, a modified ceramic membrane, a porous ceramic membrane, a surface modified membrane, a polymer electrolyte membrane, a porous graphene membrane, and a polymeric membrane. The hot compartment 104 and the cold compartment 106 are alternatively referred to as “the saltwater feed compartment” and “the water compartment” in the present disclosure. The water compartment 106 includes a DCMD condenser 114 to condense the water vapor passing through the membrane and entering the water compartment 106.

The system 100 further includes a seawater tank 112 that is in fluid communication with the condenser 114 and an evaporator 116 via a seawater pump 118. With aid of the seawater pump 118, the seawater tank 112 is configured to supply a seawater stream to the condenser 114 and the evaporator 116. In some embodiments, the seawater pump 118 may be configured to pump a portion of the seawater stream to the condenser 114 and the evaporator 116. In some embodiments, the seawater pump may be an axial flow pump. The condenser 114 is in fluid communication with an adsorber 120, a desorber 122, and the hot compartment 104. The condenser 114 is configured to pass a heated condensed seawater stream to the adsorber 120 via a second valve “V2” and to the hot compartment 104 via a supply line “L1” and pass a heated desorbed seawater stream to the desorber 122 via a fourth valve “V4”.

The system 100 further includes a hot water tank 124 that is disposed in fluid communication with the desorber 122. A supply line “L2” extends between a desorber outlet 126 and the hot water tank 124 and a supply line “L3” extends between the hot water tank 124 and a desorber inlet 128 as shown in the FIG. 1A. Such supply lines help establish the fluid communication between the hot water tank 124 and the desorber 122. The heated desorbed seawater stream flowing through the desorber 122 flows through the supply line “L2” and into the hot water tank 124. The hot water tank 124 is configured to heat the heated desorbed seawater stream leaving the desorber outlet 126 and return the heated desorbed seawater stream to the desorber 122 through the desorber inlet 128.

The adsorber 120 and the desorber 122 are individually in fluid communication with the evaporator 116 and configured to pass a cooled evaporated seawater stream to the evaporator 116 via a first valve “V1” and the third valve “V3”, respectively. In some embodiments, the adsorber 120 and the desorber 122 may be housed conjoined within a same housing. In some embodiments, the adsorber 120, the desorber 122, the condenser 114, and the evaporator 116 may be together housed within the same housing. In some embodiments, each of the first valve “V1”, the second valve “V2”, the third valve “V3”, and the fourth valve “V4” may be gate valves. In some embodiments, the first valve “V1” and the fourth valve “V4” may be parallel disc gate valves. In some embodiments, the second valve “V2” and the third valve “V3” may be solid-wedge gate valves.

The evaporator 116 is in fluid communication with a brine tank 130 and configured to pass a brine stream to the brine tank 130. The hot compartment 104 of the DCMD module 102 is also in fluid communication with the brine tank 130 and is configured to pass a separated brine stream to the brine tank 130. The condenser 114 is in fluid communication with a freshwater tank 132 and configured to pass a freshwater stream to the freshwater tank 132. The cold compartment 106 of the DCMD module 102 is in fluid communication with a coolant tank 134 and configured to pass a separated freshwater stream to the coolant tank 134, and the coolant tank is configured to return a separated saltwater stream to the cold compartment 106. Further, the coolant tank 134 is in fluid communication with the freshwater tank 132 and configured to pass the separated freshwater stream to the freshwater tank 132.

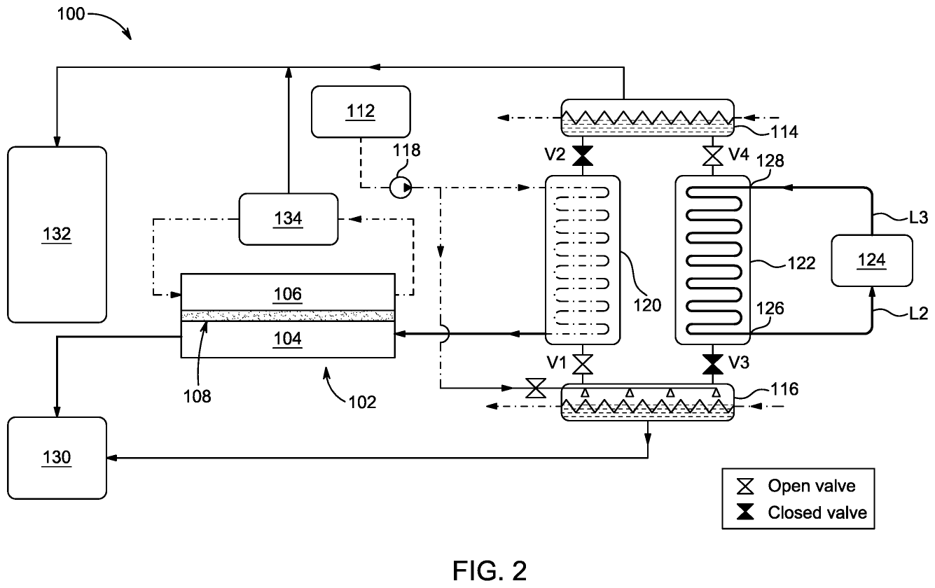

FIG. 2 illustrates a second exemplary configuration of the system 100, according to an aspect of the present disclosure. In this configuration, the seawater tank 112 is in direct fluid communication with the adsorber 120 and the evaporator 116. The seawater tank 112 is configured to pass the seawater stream to the adsorber 120 and the evaporator 116. In such an arrangement, the seawater pump 118 is configured to pump a portion of the seawater stream to the adsorber 120 and the evaporator 116. Further, the adsorber 120 is in direct fluid communication with the hot compartment 104 of the DCMD module 102 and configured to pass an adsorber stream to the hot compartment 104. Description of other components of the system 100 and arrangements with respect to the other components remain the same and hence are not repeated for the purpose of brevity.

Although the FIG. 1 and FIG. 2 herein illustrate a single DCMD module 102, it should be understood that the illustrated arrangement is exemplary in nature and the system 100 may include multiple such DCMD modules. In some embodiments, the system 100 may include 5 to 25 DCMD modules. In some embodiments, the DCMD modules may be arranged either in a counter-current configuration or in a parallel/cross flow configuration. In an embodiment, a first DCMD module outlet of a first DCMD module may be in fluid communication with a second DCMD module inlet of a second DCMD module. In such an arrangement, a DCMD stream may be passed from the first DCMD module outlet to the second DCMD module inlet. In order to achieve such supply of the DCMD stream, in an embodiment, the first DCMD module outlet and the second DCMD module inlet may be disposed at the same height relative to a first membrane in the first DCMD module and a second membrane in the second DCMD module. Further, in an embodiment, the first DCMD module may be in fluid communication with the coolant tank 134 and configured to pass a coolant tank stream from the coolant tank 134 to the first DCMD module through a first DCMD module inlet. In some embodiments, a terminal DCMD module may be in fluid communication with the coolant tank 134 and configured to return a terminal DCMD stream from the terminal DCMD module to the coolant tank 134 through a terminal DCMD module outlet.

According to aspects of the present disclosure, various parameters of the system 100 may be determined through the following mathematical modelling which are applicable to the configurations illustrated in FIG. 1 and FIG. 2. For example, permeate mass flux (J) of the membrane 108 may be estimated by considering a difference between vapor pressures on either sides of the membrane 108, such as the hot compartment 104 (feed side) and the cold compartment 106 (permeate side). The permeate mass flux (J) may be determined using the following equation [See: M. Khayet, Membranes and theoretical modeling of membrane distillation: A review, Advances in Colloid and Interface Science. 164 (2011) 56-88; M. Essalhi, M. Khayet, Self-sustained webs of polyvinylidene fluoride electrospun nanofibers at different electrospinning times: 2. Theoretical analysis, polarization effects and thermal efficiency, Journal of Membrane Science. 433 (2013) 180-191; Z. W. Song, L. Y. Jiang, Optimization of morphology and performance of PVDF hollow fiber for direct contact membrane distillation using experimental design, Chemical Engineering Science. 101 (2013) 130-143, incorporated herein by reference in their entirety]:

$$J = {D}_{e} Δ {p}_{m} = {D}_{e} ( {p}_{mf} - {p}_{m p}^{*} ) \qquad ( 1 )$$

where Dₑ is an equivalent diffusion coefficient and pₘ indicates the difference in vapor pressure at transmembrane surfaces. p_{mf} and p*ₘₚ are partial pressures at the feed side and the permeate side of the membrane 108, respectively.

Further, the partial pressures, such as p_{mf} and p*mp, may be calculated based on an assumption that surfaces of the membrane 108 are in thermodynamic equilibrium [See: K. W. Lawson, D. R. Lloyd, Membrane distillation, Journal of Membrane Science. 124 (1997) 1-25, incorporated herein by reference in its entirety]. The salinity of sodium chloride in the seawater stream affects the partial pressures at the feed side, which needs to be taken into account when calculating the partial pressures [See: T. C. Chen, C. D. Ho, H. M. Yeh, Theoretical modeling and experimental analysis of direct contact membrane distillation, Journal of Membrane Science. 330 (2009) 279-287, incorporated herein by reference in its entirety].

$${p}_{mf} = {p}_{mf}^{*} {X}_{wf} {a}_{wf} \qquad ( 2 )$$

where a_{wf} and X_{wf} denote the activity coefficient and the water mole fraction in the feed side, respectively. The activity coefficient for an aqueous solution of sodium chloride is given by [See: M. S. Khayet, T. Matsuura, Membrane distillation: principles and applications, (2011) 477; M. Essalhi, M. Khayet, Self-sustained webs of polyvinylidene fluoride electrospun nanofibers at different electrospinning times: 2. Theoretical analysis, polarization effects and thermal efficiency, Journal of Membrane Science. 433 (2013) 180-191; T. C. Chen, C. D. Ho, H. M. Yeh, Theoretical modeling and experimental analysis of direct contact membrane distillation, Journal of Membrane Science. 330 (2009) 279-287; J. Phattaranawik, R. Jiraratananon, A. G. Fane, Effect of pore size distribution and air flux on mass transport in direct contact membrane distillation, Journal of Membrane Science. 215 (2003) 75-85, incorporated herein by reference in their entirety].

$${a}_{wf} = 1 - 0.5 {X}_{NaCl} - 10 {X}_{NaCl}^{2} \qquad ( 3 )$$

p*_{mf} and p*ₘₚ, are the vapor pressures of water and may be calculated at surface temperatures Tₘᵣ and Tₘₚ of the membrane 108, using the Antoine equation as follows:

$${p}_{mf}^{*} = exp ( 23.1964 - \frac{3 816.44}{( {T}_{mf} - 46.13 )} ) \qquad ( 4 )$$

$${p}_{m p}^{*} = exp ( 23.1964 - \frac{3816.44}{( {T}_{m p} - 46.13 )} ) \qquad ( 5 )$$

Transport of gases and vapor through porous media, such as the membrane 108, is explained by three different mechanisms. They are the Poiseuille flow model, the Knudsen flow model, and the molecular diffusion model. With respect to DCMD module 102, models like the Knudsen flow and molecular diffusion are applicable. There is no trans-membrane hydrostatic pressure exerted because both the feed and the permeate solutions are kept under constant pressure (about 1 atm) inside the membrane 108. Therefore, the Poiseuille flow model is insignificant in this case [See: J. A. Sanmartino, M. Khayet, M. C. García-Payo, Desalination by Membrane Distillation, Emerging Membrane Technology for Sustainable Water Treatment. (2016) 77-109, incorporated herein by reference in its entirety]. A combined influence of molecular and Knudsen diffusions was calculated using the ratio of Knudsen diffusion to molecular diffusion (a). The controlling mechanism in the mass transfer is determined by the ratio α whose value varies from 0 to 1 and can be given as [See: M. Essalhi, M. Khayet, Self-sustained webs of polyvinylidene fluoride electrospun nanofibers at different electrospinning times: 2. Theoretical analysis, polarization effects and thermal efficiency, Journal of Membrane Science. 433 (2013) 180-191, incorporated herein by reference in its entirety]:

$$α = 0.9469 ( \frac{{d}_{pore}}{{d}_{i}} ) + 0.0796 \qquad ( 6 )$$

where dₚₒᵣₑ and dᵢ are the mean fiber diameter and the size of inter-fiber space of the membrane, respectively. The value of dᵢ was taken 51.1×10⁻⁷ [See: M. Essalhi, M. Khayet, Self-sustained webs of polyvinylidene fluoride electrospun nanofibers at different electrospinning times: 2. Theoretical analysis, polarization effects and thermal efficiency, Journal of Membrane Science. 433 (2013) 180-191, incorporated herein by reference in its entirety].

$${D}_{e} = {( ( \frac{∝}{{D}_{k}} ) + ( \frac{1 - ∝}{{D}_{m}} ) )}^{- 1} \qquad ( 7 )$$

where Dₑ, Dₖ, and Dₘ represent the effective, Knudsen, and molecular diffusion coefficients, respectively. Dₖ, and Dₘ are determined using the following expressions [See: A. Khalifa, H. Ahmad, M. Antar, T. Laoui, M. Khayet, Experimental and theoretical investigations on water desalination using direct contact membrane distillation, Desalination. 404 (2017) 22-34, incorporated herein by reference in its entirety]:

$${D}_{k} = {( ( \frac{3 φ}{2 ε {d}_{pore}} ) {( \frac{π R {T}_{m}}{8 {M}_{w}} )}^{0.5} )}^{- 1} \qquad ( 8 )$$

$${D}_{M} = {( \frac{R {T}_{m} φ {P}_{air , pore}}{{M}_{w} ε {PD}_{w , a}} )}^{- 1} \qquad ( 9 )$$

where P is the total pressure inside the pore in the membrane 108 (assumed to be constant and equal to the sum of the air and water partial pressures), D_{w,a} is pressure independent molecular diffusion coefficient of water in the air, and φ is the hypothesis path through the membrane 108, which is given as [See: N. A. Mohammad Ameen, S. S. Ibrahim, Q. F. Alsalhy, A. Figoli, Highly Saline Water Desalination Using Direct Contact Membrane Distillation (DCMD): Experimental and Simulation Study, Water 2020, Vol. 12, Page 1575. 12 (2020) 1575, incorporated herein by reference in its entirety]:

$$φ = δ τ \qquad ( 10 )$$

where δ is a thickness of the membrane 108 and τ is a tortuosity of the membrane 108 which can be calculated as [See: S. B. Iversen, V. K. Bhatia, K. Dam-Johansen, G. Jonsson, Characterization of microporous membranes for use in membrane contactors, Journal of Membrane Science. 130 (1997) 205-217, incorporated herein by reference in its entirety]:

$$τ = \frac{1}{ε} \qquad ( 11 )$$

Further, PD_{w,a} (unit of which is Pa m²/s) is estimated using the following formula, which can be used in the temperature range of 273 K to 373 K [See: J. Phattaranawik, R. Jiraratananon, A. G. Fane, Effect of pore size distribution and air flux on mass transport in direct contact membrane distillation, Journal of Membrane Science. 215 (2003) 75-85, incorporated herein by reference in its entirety].

$${PD}_{w , a} = 1.895 \times 1 {0}^{- 5} {T}_{m}^{2.072} \qquad ( 12 )$$

$${T}_{m} = \frac{{T}_{mf} + {T}_{m p}}{2} \qquad ( 13 )$$

When the membrane 108 is filled with air and water vapors, the partial pressure of air inside the pores of a membrane 108 may be calculated using the following formula:

$${P}_{air , pore} = {P}_{pore} - {P}_{wvp} \qquad ( 14 )$$

where P_{wvp} is the partial pressure of water vapors inside the pores, which can be determined using the Antoine equation based on a mean temperature (Tₘ) across the surfaces of the membrane 108, and Pₚₒᵣₑ is the total pressure inside the pores, which is assumed to be an average of feed side pressure and permeate side pressure. Pₚₒᵣₑ may be determined using:

$${P}_{pore} = \frac{{P}_{f} + {P}_{p}}{2} \qquad ( 15 )$$

Further, various heat transfer parameters are associated with the DCMD module 102. For example, at the feed side, where water flows over the surface of the membrane 108 at high temperature and salinity, the heat transfer is due to convection. The fluid then flows on the permeate side, resulting in convective heat transfer. Heat is transferred across the membrane 108 via conduction and mass flux. Hence, heat transfer in the DCMD module 102 occurs in three zones:

Convective heat transfer (Q_{f}) from the feed side to the surface of the membrane 108, is governed by Newton's law of cooling [See: N. A. Mohammad Ameen, S. S. Ibrahim, Q. F. Alsalhy, A. Figoli, Highly Saline Water Desalination Using Direct Contact Membrane Distillation (DCMD): Experimental and Simulation Study, Water 2020, Vol. 12, Page 1575, incorporated herein by reference in its entirety]:

$${Q}_{f} = {h}_{f} ( {T}_{bf} - {T}_{mf} ) \qquad ( 16 )$$

where T_{bf} is the mean feed bulk temperature of inlet and outlet of the hot feed stream and h_{f} denotes the convective heat transfer coefficient in the feed side, which depends on the type of flow (laminar or turbulent).

A total heat flux (Qₘ) across the membrane 108 is calculated by adding the heat transfer through the membrane 108 by conduction (Q_{c}) to the evaporative mass flux through the pores (Qᵥ) [See: I. Janajreh, D. Suwwan, R. Hashaikeh, Assessment of direct contact membrane distillation under different configurations, velocities and membrane properties, Applied Energy. 185 (2017) 2058-2073, incorporated herein by reference in its entirety].

$${Q}_{m} = {Q}_{c} + {Q}_{v} \qquad ( 17 )$$

$${Q}_{c} = ( \frac{{k}_{m}}{δ} ) ( {T}_{mf} - {T}_{m p} ) \qquad ( 18 )$$

$${Q}_{v} = J Δ {H}_{v} \qquad ( 19 )$$

where kₘ is the effective thermal conductivity of the membrane, which is predicated on both gas and membrane polymer conductivities [See: J. Phattaranawik, R. Jiraratananon, A. G. Fane, Heat transport and membrane distillation coefficients in direct contact membrane distillation, Journal of Membrane Science. 212 (2003) 177-193, incorporated herein by reference in their entirety]. Depending on the isostress series model, the effective thermal conductivity of the membrane matrix consists of the thermal conductivity of gas (air and water vapor) k_{g} and membrane solid kₘₑₘ and can be determined as follows [See: L. Francis, N. Ghaffour, A. A. Alsaadi, G. L. Amy, Material gap membrane distillation: A new design for water vapor flux enhancement, Journal of Membrane Science. 448 (2013) 240-247, incorporated herein by reference in their entirety]:

$${k}_{m} = {( ( \frac{ε}{{k}_{g}} ) + ( \frac{1 - ε}{{k}_{m e m}} ) )}^{- 1} \qquad ( 20 )$$

ΔHᵥ, is the enthalpy of vaporization of water; and it is given as:

$$Δ {H}_{v} = 1.7 \; 535 {T}_{mf} + 2024.3 \qquad ( 21 )$$

Further, convective heat transfer (Qₚ) from surface of the membrane 108 to the permeate side is determined using:

$${Q}_{p} = {h}_{p} ( {T}_{m p} - {T}_{bp} ) \qquad ( 22 )$$

where T_{bp} is the average permeate bulk temperature of the inlet and outlet of the cold permeate stream and hₚ is the convective heat transfer coefficient in the permeate side, which depends on the flow type (laminar or turbulent) and can be calculated using different correlations. The following energy conservation is valid under steady-state conditions:

$${Q}_{f} = {Q}_{m} = {Q}_{p} \qquad ( 23 )$$

The temperatures of the feed side and the permeate side of the membrane 108 are given as:

$${T}_{mf} = \frac{{k}_{m} ( {T}_{bp} + \frac{{h}_{f}}{{h}_{p}} {T}_{bf} ) + δ ( {h}_{f} {T}_{bf} - J Δ {H}_{v} )}{{k}_{m} + {h}_{f} ( δ + \frac{{k}_{m}}{{h}_{p}} )} \qquad ( 24 )$$

$${T}_{mp} = \frac{{k}_{m} ( {T}_{bf} + \frac{{h}_{p}}{{h}_{f}} {T}_{bp} ) + δ ( {h}_{p} {T}_{bp} + J Δ {H}_{v} )}{{k}_{m} + {h}_{p} ( δ + \frac{{k}_{m}}{{h}_{f}} )} \qquad ( 25 )$$

In some aspects, these temperatures can be used to calculate the vapor pressures using Eq. (4) and Eq. (5), and then the permeate flux can be determined using Eq. (1).

The convective heat transfer coefficient is defined as follows:

$$h = \frac{Nu k}{{D}_{h}} \qquad ( 26 )$$

In case of laminar channel flow, the following correlation for Nusselt Number [See: L. Martinez-Diez, M. I. Vizquez-Gonzilez, Temperature and concentration polarization in membrane distillation of aqueous salt solutions, Journal of Membrane Science. 156 (1999) 265-273; S. Srisurichan, R. Jiraratananon, A. G. Fane, Mass transfer mechanisms and transport resistances in direct contact membrane distillation process, Journal of Membrane Science. 277 (2006) 186-194, incorporated herein by reference in their entirety] is valid for both the feed side and the permeate side:

$$Nu = 1.86 {( \frac{Re \times Pr \times {D}_{h}}{L} )}^{0.33} \qquad ( 27 )$$

Pr is the Prandtl number which is defined as the ratio of viscous diffusion rate to thermal diffusion rate, and is given by:

$$Pr = \frac{v}{∝} = \frac{μ {C}_{p}}{k} \qquad ( 28 )$$

In case of turbulent channel flow, the Nusselt number of the feed side and the permeate side are calculated as follows [See: M. Essalhi, M. Khayet, Self-sustained webs of polyvinylidene fluoride electrospun nanofibers at different electrospinning times: 2. Theoretical analysis, polarization effects and thermal efficiency, Journal of Membrane Science. 433 (2013) 180-191; K. W. Lawson, D. R. Lloyd, Membrane distillation, Journal of Membrane Science. 124 (1997) 1-25, incorporated herein by reference in their entirety]

$${Nu}_{f} = 0.027 {( {Re}_{f} )}^{0.8} {( {Pr}_{f} )}^{0.4} {( \frac{{μ}_{bf}}{{μ}_{mf}} )}^{0.14} \qquad ( 29 )$$

$${Nu}_{p} = 0.027 {( {Re}_{p} )}^{0.8} {( {Pr}_{p} )}^{0.3} {( \frac{{μ}_{mp}}{{μ}_{bp}} )}^{0.14} \qquad ( 30 )$$

An overall heat transfer, Qₘ, in the membrane 108 can be represented in terms of the heat transfer coefficient, H, as follows:

$${Q}_{m} = H ( {T}_{bf} - {T}_{bp} ) \qquad ( 31 )$$

Based on a temperature differential between the feed side and permeate side, the following expression can be utilized to calculate the total heat transfer coefficient [See: Y. M. Manawi, M. Khraisheh, A. K. Fard, F. Benyahia, S. Adham, Effect of operational parameters on distillate flux in direct contact membrane distillation (DCMD): Comparison between experimental and model predicted performance, Desalination. 336 (2014) 110-120, incorporated herein by reference in its entirety]:

$$H = {[ \frac{1}{{h}_{f}} + \frac{1}{( \frac{{k}_{m}}{δ} ) + \frac{J Δ {H}_{v}}{( {T}_{mf} - {T}_{mp} )}} + \frac{1}{{h}_{p}} ]}^{- 1} \qquad ( 32 )$$

To this end, few assumptions are considered prior to modelling the AD module of the system 100. The assumptions include, but not limited to, the homogeneity of the adsorbent material, well-insulation of the components of the system 100, and disregarding the resistance between the adsorbent and tubes.

An amount of water vapor adsorbed can be evaluated by means of adsorption kinetics. For water vapor sorption, the Dubnin-Astackov (D-A) model is more applicable, according to Alsaman. Et.al [See: A. S. Alsaman, A. A. Askalany, K. Harby, M. S. Ahmed, Performance evaluation of a solar-driven adsorption desalination-cooling system, Energy. 128 (2017) 196-207, incorporated herein by reference in its entirety]

$${q}_{eq} = {q}_{max} exp ( - {( \frac{RT}{E} ln ( \frac{{P}_{bed , sat}}{{P}_{sorp}} ) )}^{n} ) \qquad ( 33 )$$

where, q_{eq} and qₘₐₓ denote the equilibrium adsorption capacity as determined by isotherms of adsorption and maximum adsorption amount, respectively.

Actual adsorption uptake (q) is predicted using the linear driving force (LDF) model as follows [See: N. A. A. Qasem, R. Ben-Mansour, Adsorption breakthrough and cycling stability of carbon dioxide separation from CO2/N2/H2O mixture under ambient conditions using 13X and Mg-MOF-74, Applied Energy. 230 (2018) 1093-1107; N. A. A. Qasem, R. Ben-Mansour, M. A. Habib, An efficient CO2 adsorptive storage using MOF-5 and MOF-177, Applied Energy. 210 (2018) 317-326; N. A. A. Qasem, R. Ben-Mansour, Energy and productivity efficient vacuum pressure swing adsorption process to separate CO2 from CO2/N2 mixture using Mg-MOF-74: A CFD simulation, Applied Energy. 209 (2018) 190-202; R. Ben-Mansour, N. A. A. Qasem, M. A. Antar, Carbon dioxide adsorption separation from dry and humid CO2/N2 mixture, Computers & Chemical Engineering. 117 (2018) 221-235, incorporated herein by reference in their entirety]:

$$\frac{dq}{dt} = {k}_{L} ( {q}_{eq} - q ) \qquad ( 34 )$$

Here, k_{L} (having unit as 1/s) is the LDF constant, which can be determined as [See: A. S. Alsaman, A. A. Askalany, K. Harby, M. S. Ahmed, Performance evaluation of a solar-driven adsorption desalination-cooling system, Energy. 128 (2017) 196-207, incorporated herein by reference in its entirety]:

$${k}_{L} = \frac{{A}_{0} {D}_{c}}{{r}_{P}^{2}} exp ( \frac{- {E}_{a}}{RT} ) \qquad ( 35 )$$

During the adsorption/desorption process, energy of the sorption beds is conserved And can be expressed as:

$${[ {( {mC}_{P} )}_{tubes} + {( {mC}_{P} )}_{fins} + {( {mC}_{P} )}_{s} + {m}_{s} {C}_{v} q ]}_{bed} \frac{{dT}_{bed}}{dt} = {m}_{s} Δ H \frac{dq}{dt} + \dot{{m}_{w}} {C}_{P , w} ( {T}_{w , i} - {T}_{w , e} ) \qquad ( 36 )$$

where (mCₚ)_{tubes}, (mCₚ)_{fins}, (mCₚ)ₛ, and mₛCᵥq represent the heat stored in tubes, fins, the adsorbent (such as silica gel), and adsorbed water vapor, respectively. The subscript ‘w’ stands either for cooling water or heating water depending on the process (for example adsorption, desorption, precooling, or preheating). The first term on the left-hand side (Eq. 36) is zero for preheating and pre-cooling switching processes. In Eq. 36, ΔH denotes the adsorption heat, which is determined using adsorption isotherm curves as [See: D. M. Ruthven, Fundamentals of Adsorption Equilibrium and Kinetics in Microporous Solids, Molecular Sieves—Science and Technology. 7 (2006) 1-43, incorporated herein by reference in its entirety]:

$$Δ H = {h}_{fg} + E {ln ( \frac{{q}_{max}}{{q}_{eq}} )}^{\frac{1}{n}} + \frac{E \times T \times CR}{n} {ln ( \frac{{q}_{max}}{{q}_{eq}} )}^{\frac{( 1 - n )}{n}} \qquad ( 37 )$$

where h_{fg} (in kJ/kg) stands for vaporization/condensation latent heat and CR stands for capital recovery ratio or amortization charge.

During the desorption process, the water vapor that has been desorbed is collected by the AD condenser (such as the condenser 114), where the water vapor gets condensed before leaving the system 100 as freshwater. The heat rejects by the water vapor can be utilized to heat the DCMD feed stream (seawater stream), such as in FIG. 1. The condenser inputs and outputs mass balance is expressed as:

$$\frac{{dm}_{cond}}{dt} = {{m}_{s} ( \frac{dq}{dt} )}_{des} \qquad ( 38 )$$

where m_{cond} is considered the freshwater product of the AD system.

$${\dot{m}}_{pw , AD} = \frac{{dm}_{cond}}{dt} \qquad ( 39 )$$

The energy balance of the condenser can be expressed as:

$${[ {( {mC}_{P} )}_{tubes} + {( {mC}_{P} )}_{fins} + {( {mC}_{P} )}_{w} ]}_{cond} \frac{{dT}_{cond}}{dt} = {m}_{s} {C}_{Pwv} ( {T}_{des} - {T}_{cond} ) {( \frac{dq}{dt} )}_{des} + {m}_{s} {h}_{fg} ( {T}_{cond} ) {( \frac{dq}{dt} )}_{des} + {\dot{m}}_{cond , in} {C}_{P , w} ( {T}_{cond , in} - {T}_{cond , out} ) \qquad ( 40 )$$

The present disclosure provides a hybrid AD-DCMD system that is primarily reliant on the AD evaporator (such as the evaporator 116) because of its capability to evaporate water and provide cooling. In order to maintain the amount of liquid (saline water) inside the evaporator 116 at a constant level, salty water is fed to the evaporator 116 on an intermittent basis. When the salty water inside the evaporator 116 reaches a concentration between 180 ppt and 220 ppt, it is regularly removed as brine. This concentrate (brine) can be treated further to produce salt as a second by-product, in addition to the cooling effect. The mass and salt concentration conservation equations for the evaporator 116 are as follows:

$$\begin{matrix}\frac{d {m}_{sw , evap}}{dt} = γ {\dot{m}}_{sw , AD} - θ {\dot{m}}_{b , AD} - {m}_{s} & {( \frac{dq}{dt} )}_{ads}\end{matrix} \qquad ( 41 )$$

$${m}_{sw , evap} \frac{d {x}_{sw , evap}}{dt} = γ {x}_{sw , AD} {\dot{m}}_{sw , AD} - θ {x}_{b , AD} {\dot{m}}_{b , AD} - {x}_{ads} {{m}_{s} ( \frac{dq}{dt} )}_{ads} \qquad ( 42 )$$

Energy conservation in the evaporator 116 considers the heat stored in the evaporator 116 (water and metals (if any)), energy content of entering saline water (AD feed), energy removed by the AD brine stream, heat exchange between chilled water and evaporated water, and latent heat of vaporization. It is stated as follows:

$${[ {( m {C}_{P} )}_{tubes} + {( m {C}_{P} )}_{f i n s} + {( m {C}_{P} )}_{s w} ]}_{e v a p} \frac{d {T}_{e v a p}}{dt} = γ {\dot{m}}_{sw , AD} {h}_{sw , AD} ( {T}_{sw , AD} , {x}_{sw , AD} ) - θ {\dot{m}}_{b , AD} {h}_{b , AD} ( {T}_{e vap} , {x}_{e v a p} ) - {m}_{s} {h}_{fg} ( {T}_{e vap} , {x}_{e v a p} ) {( \frac{d q}{dt} )}_{a d s} + {\dot{m}}_{c h w} {C}_{P , chw} ( {T}_{c h w , i n} - {T}_{c h w , out} ) \qquad ( 43 )$$

If salty water is being fed into the evaporator 116, the value of y equals 1, otherwise it is zero. Similarly, θ is unity when the AD brine is released; and else zero.

Further, the adsorber 120 and the desorber 122 function as heat exchangers. The LMTD method is used to define the heat transfer processes for sorption beds, as well as the heat exchange with the secondary fluid in the condenser and the evaporator as:

$${T}_{y , out} = {T}_{E X} + ( {T}_{y , i n} - {T}_{E X} ) exp ( \frac{- U {A}_{E X}}{{( m {C}_{P} )}_{y}} ) \qquad ( 44 )$$

where “y” represents chilled water, cooling water, or heating water, and “EX” denotes the heat exchanger such as sorption beds, condenser, and evaporator.

The water production and the specific daily water production (SDWP) of the hybrid AD-DCMD system can be calculated as follows:

$${\dot{m}}_{p w} = {\dot{m}}_{pw , AD} + {\dot{m}}_{pw , DCMD} \qquad ( 45 )$$

$$SDWP = \frac{24 \times {\dot{m}}_{p w}}{{m}_{s}} \qquad ( 46 )$$

The parameter “gained output ratio” (GOR) is widely used to assess the system's efficiency. It is critical to note that the GOR values for both the AD module and the DCMD module 102 are quite low. Therefore, being both in one hybrid system significantly increases the GOR value (to almost double). The GOR is calculated for individual systems and for the hybrid system as a whole in order to demonstrate the contribution of each system. It is determined as follows:

$${GOR}_{A D} = {\int }_{0}^{{t}_{c y c l e}} \frac{{\dot{m}}_{pw , AD} {h}_{fg}}{{\dot{m}}_{h w} ( {h}_{hw , in} - {h}_{h w , o u t} )} dt \qquad ( 47 )$$

$${GOR}_{D C M D} = \frac{{\dot{m}}_{pw , DCMD} Δ {H}_{v}}{{Q}_{t}} \qquad ( 48 )$$

where Qₜ is the total heat energy removed from the hot water in the DCMD hot channel.

$${GOR}_{Total} = \frac{{\dot{m}}_{pw , AD} {h}_{fg} + {\dot{m}}_{pw , DCMD} Δ {H}_{v}}{{\dot{m}}_{h w} ( {h}_{hw , in} - {h}_{hw , out} )} \qquad ( 49 )$$

Calculating the cooling effect of the AD module in the two configurations is important. This can be expressed mathematically as the coefficient of performance (COP), which is the ratio of cooling effect to heat input as [See: N. A. A. Qasem, S. M. Zubair, Performance evaluation of a novel hybrid humidification-dehumidification (air-heated) system with an adsorption desalination system, Desalination. 461 (2019) 37-54]:

$$C O P = {\int }_{0}^{{t}_{c y c l e}} \frac{{\dot{m}}_{c h w} ( {h}_{c hw , i} - {h}_{chw , o} )}{{\dot{m}}_{h w} ( {h}_{hw , in} - {h}_{hw , out} )} d t \qquad ( 50 )$$

The beds used in the AD module are regarded the same as those described in the published experiment due to an optimized bed filled with silica-gel, which is readily available in the market as a low-cost and stable material. Table 2 below presents the operating parameters of the DCMD module 102, and it also lists the parameters of the two identical beds, the condenser 114 and the evaporator 116. The equilibrium and kinetic adsorption parameters of the silica-gel and the H₂O pair which are necessary for calculating the equilibrium and actual uptakes (q_{eq} and q) are listed in Table 1. Ambient pressure (101.3 kPa) is assumed as the operating pressure for the DCMD module 102. It is important to notice that thermal property fluctuation is considered. The thermodynamic properties of water are calculated using the REFPROP software [NIST Reference Fluid Thermodynamic and Transport Properties Database]. Initial values for the operating conditions are listed in Table 3. The simulation is carried out using the MATLAB software with a computational tolerance error of <10⁻⁶.

TABLE 1
Adsorption isotherm data of the silica-gel/water pair
[See: A. S. Alsaman, A. A. Askalany , K. Harby, M.
S. Ahmed, Performance evaluation of a solar-driven adsorption
desalination-cooling system, Energy. 128 (2017) 196-207,
incorparated herein by reference in its entirety]

| Property | Value | |
|---|---|---|
| qₘₐₓ | 0.36 | kg/kg |
| E | 167.7 | kJ/kg |
| n | 1.68 | |
| A₀ | 32 | |
| Eₐ | 28.67 | kJ/kg |
| D_{c} | 22.5 × 10⁻⁹ | m²/s |
| rₚ | 0.00175 | m |

TABLE 2
Design and operating parameters of the AD-DCMD hybrid system

| | |
|---|---|
| Property | Value |

DCMD module

| Membrane effective area (Aₘₑₘ) | 0.175 | m² |
|---|---|---|
| Membrane feed rate (\dot{m}_{f, DCMD}) | 300 | kg/h |
| Channel width (D) | 24 | mm |
| Channel height (Ht) | 5 | mm |
| Membrane porosity (ε) | 0.85 | |
| Membrane pore size (dₚₒᵣₑ) | 1.2 | μm |
| Membrane thickness (δ) | 151.8 | μm |
| Cold stream inlet temperature (T_{bp}) | 20° | C. |

| | |
|---|---|
| Hot stream inlet temperature (T_{bf}) | 60° C. to 90° C. |

AD module

| | | |
|---|---|---|
| Overall heat transfer coefficient of the condenser | 0.5 | kW/K |
| (UA_{cond}) | | |
| Overall heat transfer coefficient of the evaporator | 0.35 | kW/K |
| (UAₑᵥₐₚ) | | |
| Overall heat transfer coefficient of the bed (UA_{bed}) | 0.6 | kW/K |
| Mass of bed tubes (m_{tubes}) | 2.97 | kg |
| Mass of bed fins (m_{fin}) | 0.72 | kg |
| Mass of bed heat exchanger cover (mᵢᵣₒₙ) | 15 | kg |
| Mass of condenser metal (m_{cond}) | 1.533 | kg |
| Mass of evaporator metal (mₑᵥₐₚ) | 1.3 | kg |
| Mass of silica-gel in each bed (mₛ) | 6.75 | kg |
| Bed tubes' specific heat capacity (C_{p, tube}) | 0.386 | kJ/kg · K |
| Bed fins' specific heat capacity (C_{p, fin}) | 0.905 | kJ/kg · K |
| Silica-gel's specific heat capacity (C_{p, s}) | 0.924 | kJ/kg · K |
| Mass of saline water in the evaporator (m_{sw, evap}) | 3 | kg |
| Heating water inlet temperature (T_{HW, in}) | 80° | C. |
| Cooling water inlet temperature (T_{cw, in}) | 30° | C. |

| | |
|---|---|
| Chilled water inlet temperature (T_{chw, in}) | T_{cw, in} |

TABLE 3
Initial values of operating conditions used in the calculation

| Operating condition | Initial value | |
|---|---|---|
| Effective diffusion coefficient (Dₑ) | 1.5 × 10⁻⁶ | m²/s |
| Temperature of the adsorption bed (T_{ads}) | 79° | C. |
| Temperature of the desorption bed (T_{des}) | 34° | C. |
| Uptake of the adsorption bed (q_{ads}) | 0.15 | kg/kg |
| Uptake of the desorption bed (q_{des}) | 0.26 | kg/kg |
| Temperature of the condenser (T_{cond}) | 45° | C. |
| Temperature of the evaporator (Tₑᵥₐₚ) | 30° | C. |
| Evaporator salinity (xₑᵥₐₚ) | 35 | ppt (g/kg) |
| Brine salinity (x_{b}) | 35 | ppt |

### Economic Analysis

Freshwater cost after integration may be calculated in accordance with El-Dessouky and Ettouney and Qasem and Zubair [See: N. A. A. Qasem, S. M. Zubair, Performance evaluation of a novel hybrid humidification-dehumidification (air-heated) system with an adsorption desalination system, Desalination. 461 (2019) 37-54, incorporated herein by reference in its entirety]. A list of assumptions are provided in Table 4 to simplify the freshwater cost calculation. Water is also assumed to be heated by electrical heaters, and the land cost is disregarded because the plant is located in a rural area [See: M. I. Zubair, F. A. Al-Sulaiman, M. A. Antar, S. A. Al-Dini, N. I. Ibrahim, Performance and cost assessment of solar driven humidification dehumidification desalination system, Energy Conversion and Management. 132 (2017) 28-39]. Table 5 summarizes the capital costs of the analyzed components of the DCMD module 102, and the AD module based on real purchasing prices and the made assumptions.

TABLE 4
List of the economic model assumptions.

| Factor | Value |
|---|---|
| Unit cost of electricity (COE) | 0.07$/kWh |
| Specific cost of labor (l) | $0.1/m³ |
| Annual management cost (C_{mg}) | 20% of the labor cost |
| Annual maintenance cost (C_{M}) | 1.5% of the capital investment cost |
| Interest rate (i) | 0.05 |
| Plant life expectancy (Y) | 30 years |
| Availability of the plant (f) | 0.9 |

The designs of the two configurations (FIG. 1 and FIG. 2) are used to reasonably assume the capital cost of the AD-DCMD hybrid system, as stated in Table 5. The following equations can be used to estimate the total costs, including the operating costs.

Capital recovery ratio (CR), or amortization charge [See: M. A. Jamil, S. M. Zubair, On thermoeconomic analysis of a single-effect mechanical vapor compression desalination system, Desalination. 420 (2017) 292-307, incorporated herein by reference in its entirety] may be calculated as:

$$C R = \frac{{i ( i + 1 )}^{Y}}{{( i + 1 )}^{Y} - 1} \qquad ( 51 )$$

The annual capital cost (in $/yr) may be calculated as:

$${C}_{A} = {C}_{c} \times C R \qquad ( 52 )$$

The annual power cost (in $/yr) may be calculated as:

$$C P = C O E \times \frac{e}{3600} \times f \times {\dot{m}}_{p w} \times 3600 \times 24 \times 365 \qquad ( 53 )$$

where “e” (in kJ/kg) denotes the energy per unit mass of produced freshwater. The annual labor cost (in $/yr) may be calculated as:

$${C}_{L} = l \times f \times \frac{{\dot{m}}_{p w}}{1000} \times 3600 \times 24 \times 365 \qquad ( 54 )$$

The annual maintenance cost (in $/yr) may be calculated as:

$${C}_{M} = 0.015 \times {C}_{A} \qquad ( 55 )$$

The annual management cost (in $/yr) may be calculated as:

$${C}_{m g} = 0.2 \times {C}_{L} \qquad ( 56 )$$

Total annual freshwater Cost (in $/yr) may be calculated as:

$${C}_{T} = {C}_{A} + C P + {C}_{L} + {C}_{M} + {C}_{m g} \qquad ( 57 )$$

Cost of the produced freshwater (in $/L) may be calculated as:

$${C}_{p w} = \frac{{C}_{T}}{f \times {\dot{m}}_{p w} \times 3600 \times 24 \times 365} \qquad ( 58 )$$

TABLE 5
The capital investment cost for the AD-DCMD hybrid system

| Item | Price (US $) |
|---|---|
| Membrane | 60 ($/m²) |
| Pumps | 300 |
| Fittings/pipes | 70 |
| Accessories | 66 |
| Control devices | 80 |
| Condenser | 120 |
| Evaporator | 150 |
| Water tanks | 260 |
| Silica gel (high quality) | 5 × 2 × 6.75 |
| Adsorbent bed with fins | 2 × 120 |

### Validation of the Model

Since the hybrid AD-DCMD system (such as the system 100) was not investigated before, a validation of the model is implemented against some experimental data from the literature for standalone AD module and the DCMD module.

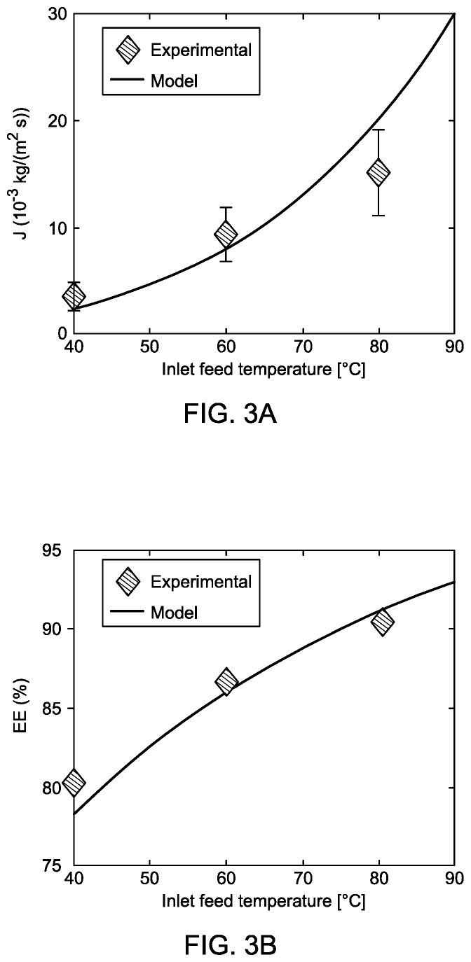

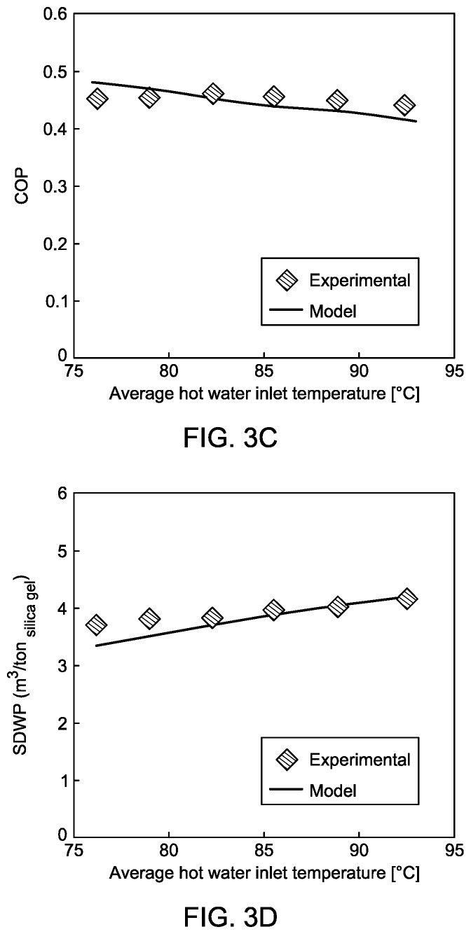

The DCMD module 102 is validated using the experimental work of Essalhi and Khayet with the same constructive and operating conditions. FIG. 3A and FIG. 3B compares a permeate flux (J) and an evaporative efficiency expected by the DCMD module 102 to an experimental data of work of Essalhi and Khayet. It may be noticed from FIG. 3A and FIG. 3B that an agreement between the model and the experimental data was obtained within an error of 0.4%-8% and 0.6%-2.4% for permeate flux and evaporative efficiency, respectively.

The experimental data of Alsaman et al. was used to validate the AD module for silica-gel/water adsorption pair. The operational and constructive parameters are listed in Table 1 and Table 2; besides, the heating water and chilled water mass flow rates are 0.2 kg/s and 0.1 kg/s, respectively. FIG. 3C and FIG. 3D illustrates a matching between the simulated and experimental COP and SDWP values with error ranges between 5.8-6.4% and 0.2-3.8% for COP and SDWP, respectively.

### Results

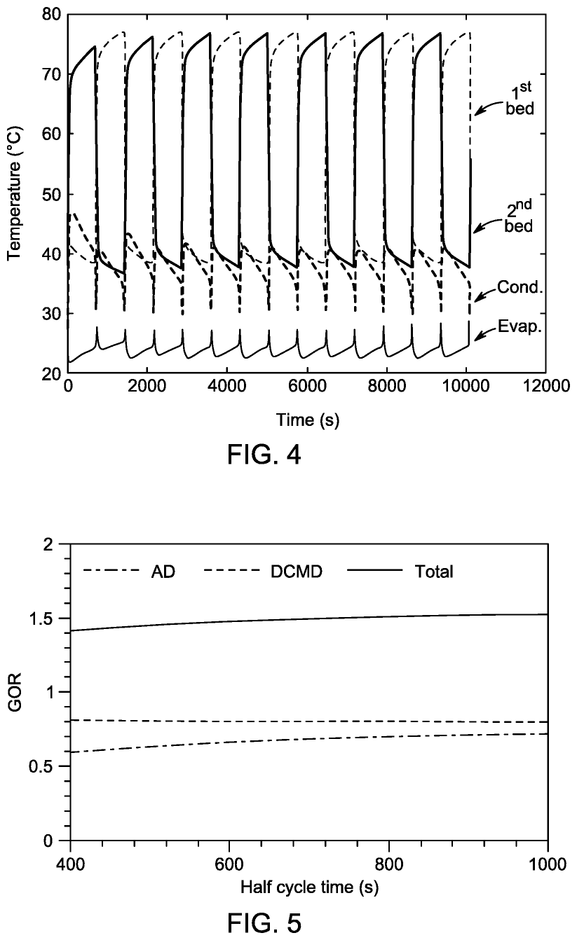

The hybrid AD-DCMD system in the first configuration (FIG. 1) and the second configuration (FIG. 2) are used to demonstrate a general thermal behavior and performance of the desalination process. Since the temperatures of the AD module components fluctuate during the adsorption/desorption process, a temperature history of the AD module was investigated for 14 cycles. FIG. 4 illustrates a temperature-time history of the AD module components, including the adsorption bed (such as the adsorber 120), desorption bed (such as the desorber 122), the evaporator 116, and the condenser 114 at steady-state conditions. Heating and cooling water temperatures were maintained at 80° C. and 30° C., respectively, while the half-cycle duration was kept at 700 s with a switching time of 20 s.

During the adsorption and desorption processes, the temperature of the bed varies between 36° C. and 76° C. The temperature of the condenser 114 also fluctuates between 37° C. and 47° C., which is relatively low. This can be attributed to the cold seawater (DCMD feed in FIG. 1) passing through the condenser 114 to be used as a heat source to operate the DCMD module 102. The temperature of the evaporator 116 was reduced to around 22° C. due to the adsorption (inside the adsorption bed) and evaporation (inside the evaporator 116) processes. The evaporator 116 was used to cool chilled water for air conditioning purposes.

In order to demonstrate a relevance of cycling time in enhancing a performance of the system 100, the GOR values behavior of the AD module, the DCMD module, and the system 100 are illustrated in FIG. 5. Total GOR values slightly increased with increasing cycle time due to a decrease in the required heating energy while the bed was hot. However, it was clear that the total GOR is almost the same for half cycle time ≥700 s. Increasing the heating time reduced the temperature difference between the hot bed and the heater. According to the presented results, the half cycle time for water production and GOR may be set to 700 s and hence used to test the other operating parameters for the two configurations (FIG. 1 and FIG. 2). At this half cycle time, the integrated system showed a higher GOR value than the AD system by 117.7%.

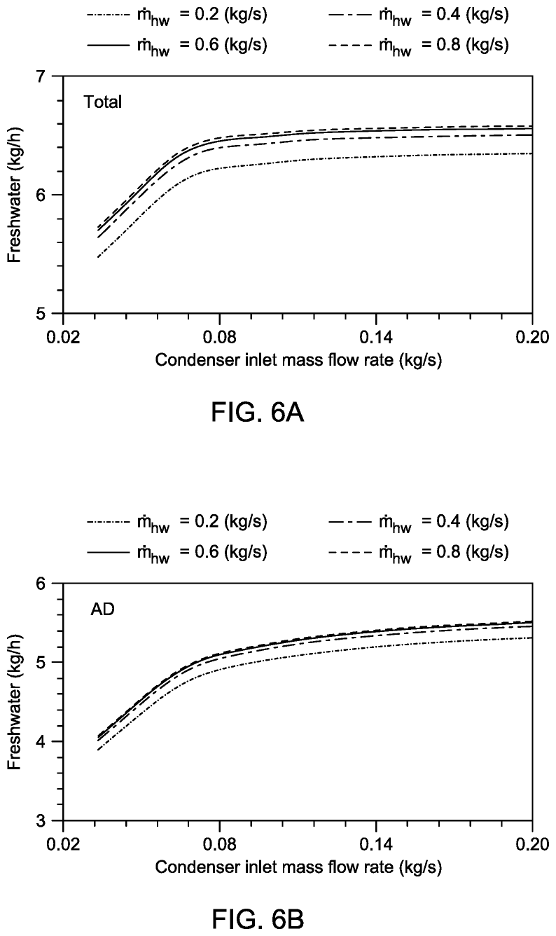

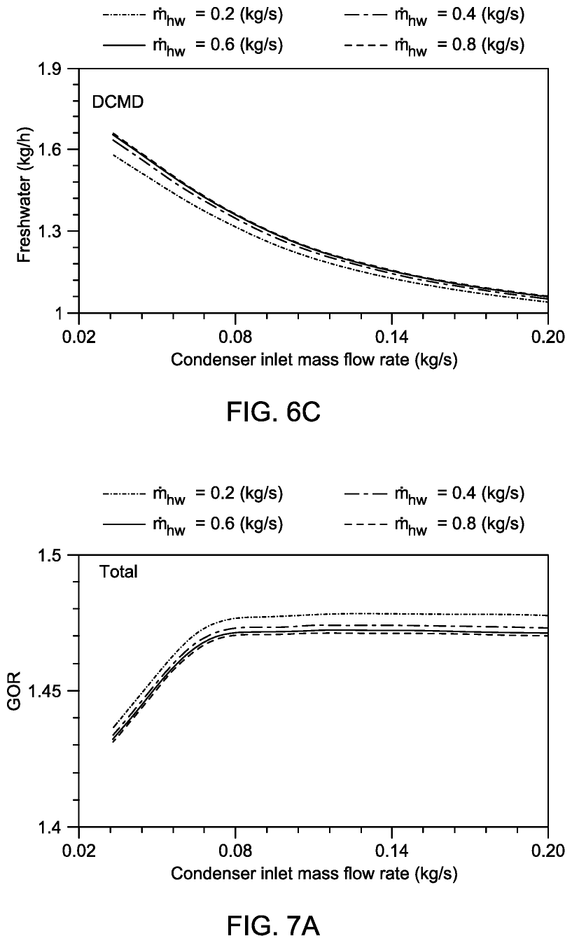

As illustrated in FIG. 6, water production of the system 100 is a function of the mass flow rate of seawater entering the condenser 114 to feed the DCMD module 102 (\dot{m}_{sw-DCMD}) and that used for heating water of the AD module (\dot{m}_{hw}). A larger amount of seawater inlet to the condenser 114 generally enhances the water production of AD module, which in turn enhances the freshwater production by the system 100. The addition of seawater could improve the condensation of water content (in the condenser 114), thereby maximizing freshwater output by the AD module. On the other hand, the freshwater produced from the DCMD module 102 decreased with increasing seawater inlet to the condenser 114 (See FIG. 6C). This can be attributed to the fact that the temperature of an outlet stream at the condenser 114 decreased with increasing the flow rate of the inlet stream (cold seawater), hence slightly decreased the DCMD permeate flux. Such slight decrease in the DCMD flux had a negligible effect on the overall freshwater production of the system 100, as illustrated by FIG. 6A. According to the results, an optimum flow rate of seawater entering the condenser 114 to feed the DCMD module 102 was 0.08 kg/s. A performance of the system 100 was not affected significantly by the amount of heating water inlet. As long as the flow rate of heating water inlet was ≥0.4 kg/s, the amount of water vapor that could be desorbed was about equal to the amount that was adsorbed onto the adsorbent. Therefore, \dot{m}_{hw} of 0.4 kg/s was taken for further calculations. FIG. 6B illustrates that increasing the heating water amounts from 0.2 kg/s to 0.8 kg/s at the AD module had a negligible effect on the total freshwater production of the system 100, which increased only by around 0.2 kg/h.

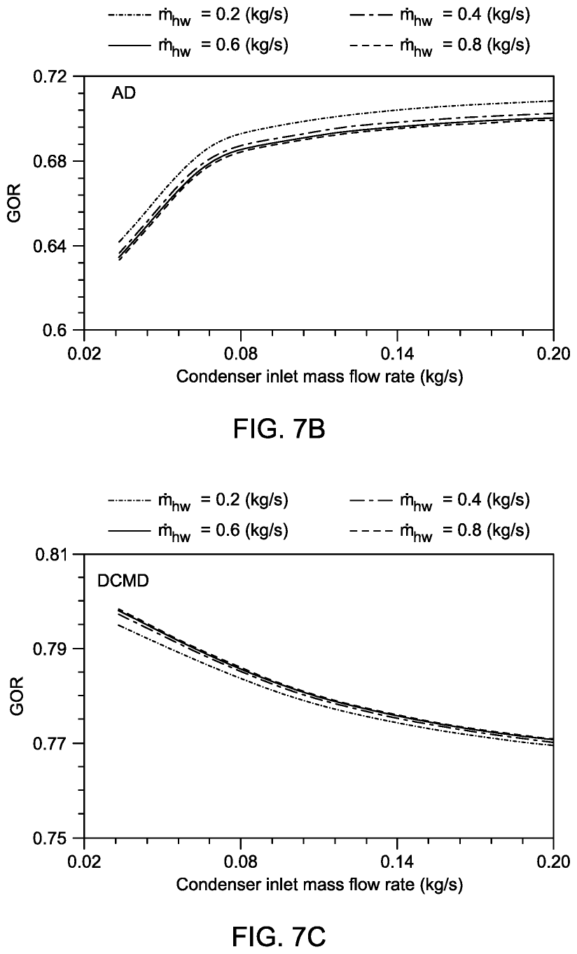

Further, as shown in FIG. 7, it may be noticed that GOR followed a similar pattern as freshwater production when changing the flow rates of seawater passing through the condenser 114 and heating water entering the desorber 122. A maximum GOR of the system 100 reached 1.48 at \dot{m}_{sw-DCMD} of 0.08 kg/s. It is clear from FIG. 7A that GOR maximum value is the same at all heating water flow rates. As such, changing the heating water flow rate doesn't significantly affect the total GOR of the system 100 in FIG. 1.

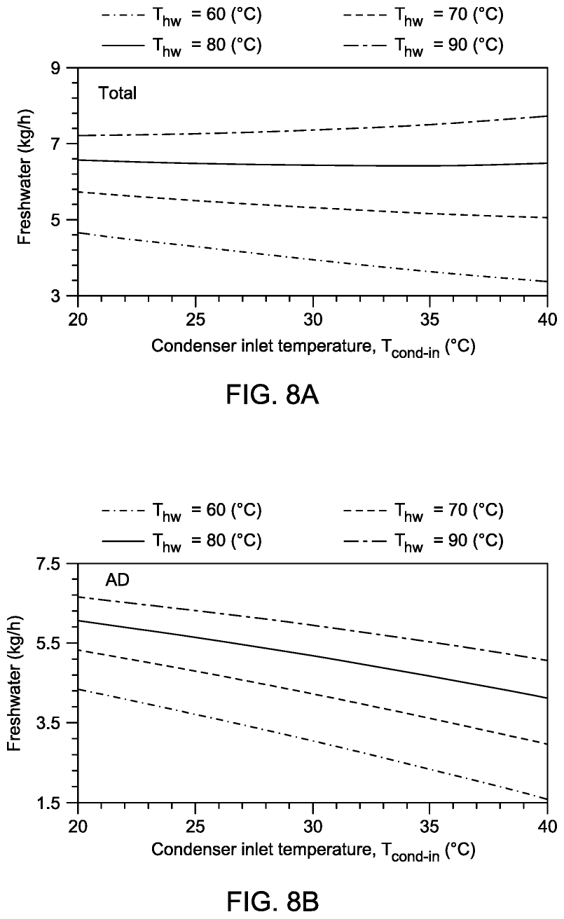

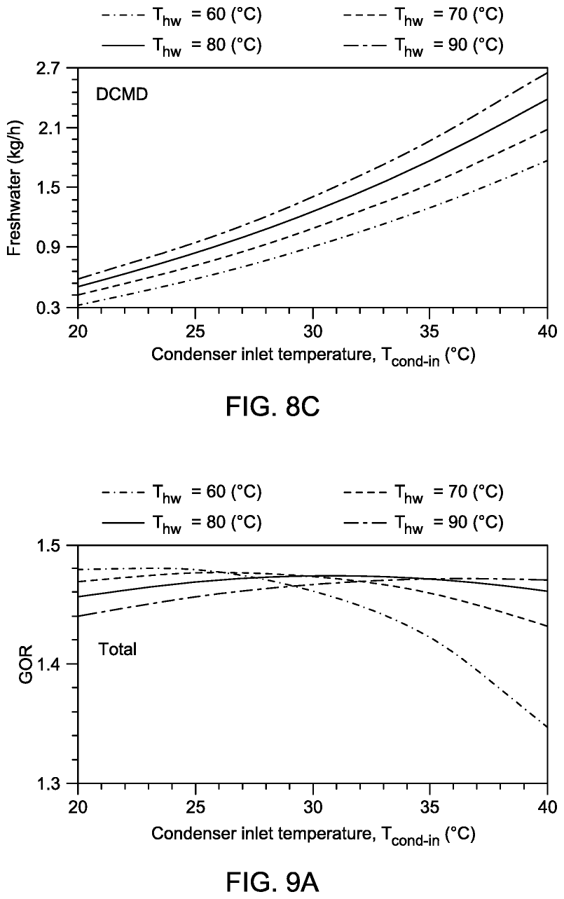

Referring to FIG. 8A, the temperature of seawater inlet (T_{cond,in}) to the condenser 114 had an appreciable effect on water production of the system 100, as may be seen, when the temperature was increased from 20° C. to 40° C. at selected heating water inlet temperature (T_{hw,in}). As T_{cond,in} increased, the temperature difference between the hot side and cold side of the condenser 114 was minimized. This resulted in a decrease in the condensed amount of freshwater inside the condenser 114, leading to a decrease in the freshwater produced from the AD module. On the other hand, at a fixed heating water inlet temperature, an increase in freshwater production of the DCMD module 102 was achieved by increasing the temperature of seawater inlet to the condenser 114, which in turn increases the feed temperature of DCMD module 102. The increased freshwater production by the DCMD module 102 was a result of high permeate flux which is due in part to the high temperature difference across the membrane 108 in addition to the other physical properties of the membrane 108, such as high porosity, high contact angle, and large pore size. This is explained by Antoine Eq. 4 and Eq. 5, in which the effect of temperature on vapor pressure is minimal at low feed temperatures but becomes much more significant at higher feed temperatures. The results also show that as the temperature of the AD heating water rises, freshwater outputs of each of the DCMD module 102, the AD module, and the system 100 increased. This can be attributed to the influence of higher heating water temperature in maximizing the desorption amounts. Then, the amount of desorbed water vapor (from the desorber 122) and the cold seawater entering the condenser 114 (to feed DCMD module 102) exchange heat in the condenser 114 leading to a significant increase in the condensed amount (freshwater by the AD module) and a rise in the inlet feed temperature of the DCMD module 102, thereby increasing amount of distillate (freshwater) in the DCMD module 102.

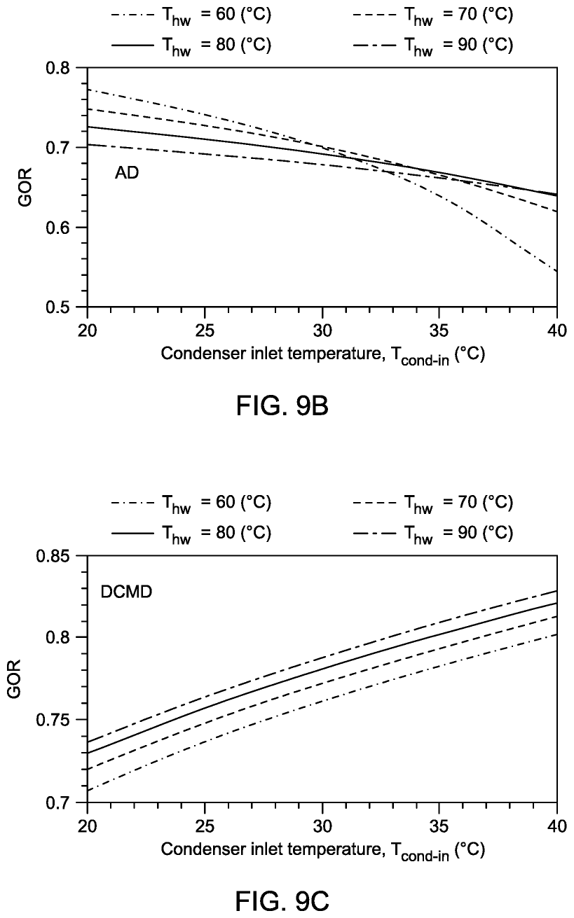

The GOR values of the system 100 and individual modules in FIG. 1 are also influenced by condenser seawater inlet temperature and heating water inlet temperature (See FIG. 9). Two scenarios may be noticed for the GOR values of the AD module (FIG. 9B). The first scenario is at T_{cond,in}>30° C., where the GOR values of the AD module increased with increasing T_{hw,in}. Such increase may be attributed to the enhancement in the desorbed water vapor amounts at higher heating temperatures, which leads to higher GOR values according to Eq. 46. In the second scenario, at T_{cond,in}<30° C., low heating water temperatures resulted in better GOR values for the AD module. For example, at T_{cond,in}=20° C. (fixed), the GOR values of the AD module are 0.7 and 0.77 at T_{hw,in} of 80° C. and 60° C., respectively. Although the heat input is low, the freshwater output was comparatively high at low inlet temperatures. As may be seen in FIG. 9C, higher GOR values for the DCMD module 102 were noticed with increasing either T_{hw,in} or T_{cond,in}. Such GOR values was due to the higher heat amount which is exchanged between the desorbed water vapor (hot) and the seawater (the DCMD feed) inside the condenser 114 resulting in increased DCMD feed temperatures and hence higher GOR values.

With reference to FIG. 9A, it was observed that the system 100 was associated with a total GOR >1.47 at T_{cond,in}≥30° C. and T_{hw,in}≥80° C. However, relatively lower GOR values were obtained at T_{hw,in}=60° C. as a direct result of the low GOR of the AD module under the same conditions. An insignificant increase in the total GOR values occurred when increasing T_{hw,in} from 80° C. to 90° C. Therefore, setting T_{hw,in}=80° C. was efficient. Based on a previously stated analysis of the effect of T_{cond,in} and T_{hw,in} on freshwater production and GOR values, the optimum T_{cond,in} and T_{hw,in} were 30° C. and 80° C., respectively.

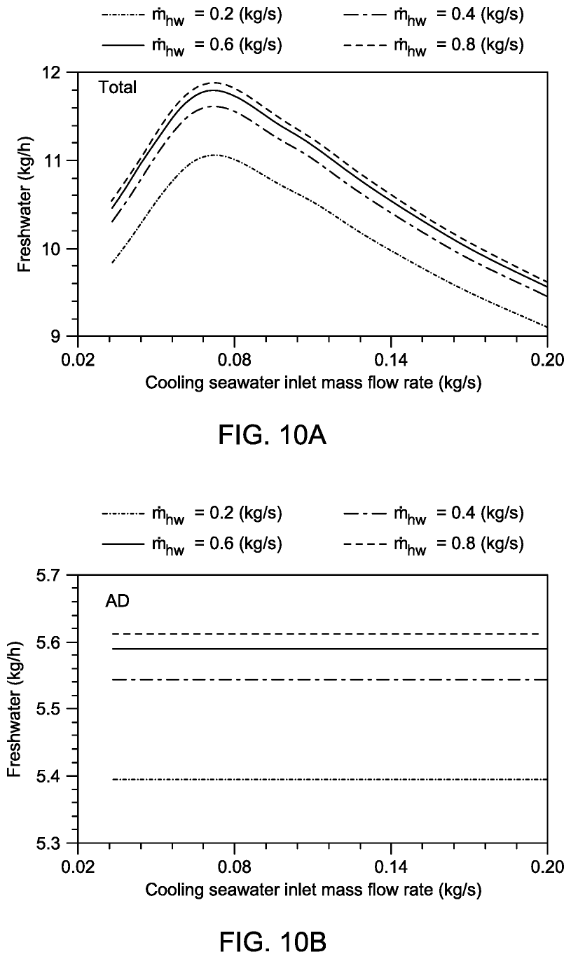

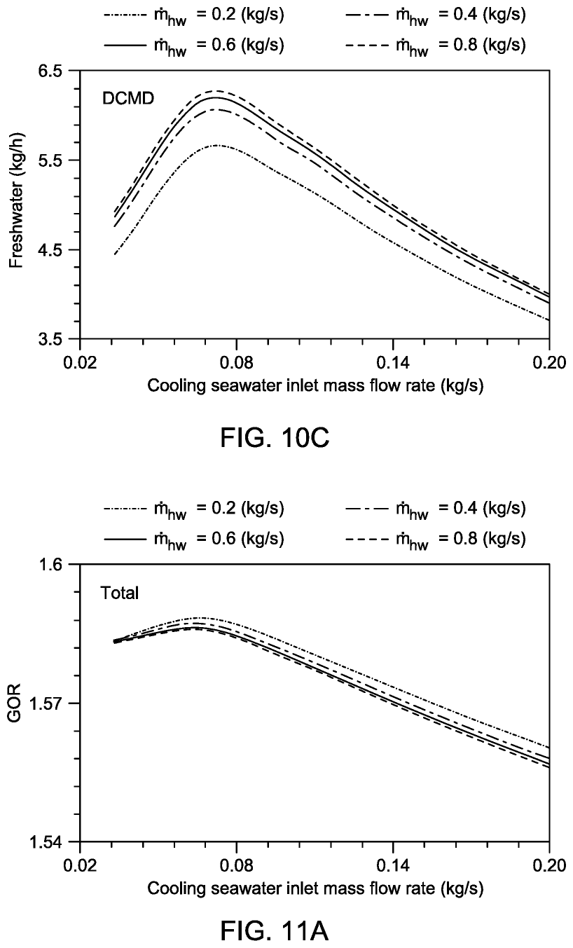

In the second configuration (that is, the system 100 in FIG. 2), the seawater (DCMD feed) was heated inside the adsorption bed (FIG. 2) instead of getting heated inside the AD condenser 114 as in the first configuration (that is, the system 100 in FIG. 1). The seawater stream (DCMD feed) was used as a pre-cooler for the adsorber 120 before entering the DCMD module 102. As shown in FIG. 10, the freshwater production of the system 100 is shown for various cooling water mass flow rates (\dot{m}_{cw}) at selected heating water mass flow rate (\dot{m}_{hw}). When the cooling water mass flow rate (\dot{m}_{cw}) of the AD module was increased while maintaining a constant heating water mass flow rate (\dot{m}_{hw}), freshwater production of the DCMD module 102 was significantly high until reaching its maximum value at \dot{m}_{cw} of 0.08 kg/s before it decreases (See FIG. 10C). For example, by increasing \dot{m}_{cw} from 0.03 kg/s to 0.08 kg/s, produced freshwater of the DCMD module 102 increased by almost 1 kg/h, which enhances the overall system productivity. This is because, at \dot{m}_{cw}<0.08 kg/s, the outlet stream from the adsorber 120 feeds the DCMD module 102 with a relatively higher temperature than that when the \dot{m}_{cw}>0.08 kg/s. Since freshwater produced from the AD module is associated with the desorber 122, the graph in FIG. 10B indicates a constant trend while changing \dot{m}_{cw}. Compared to the first configuration of FIG. 1, the second configuration of FIG. 2 produced around double the freshwater amount (See FIG. 10A). Additionally, increasing the \dot{m}_{hw} enhanced the desorption process and enlarged the heat transferred to the cooling stream (DCMD feed) inside the bed. Therefore, the total freshwater production increased. However, almost the same freshwater amounts are produced when \dot{m}_{hw}≥0.4 kg/s.

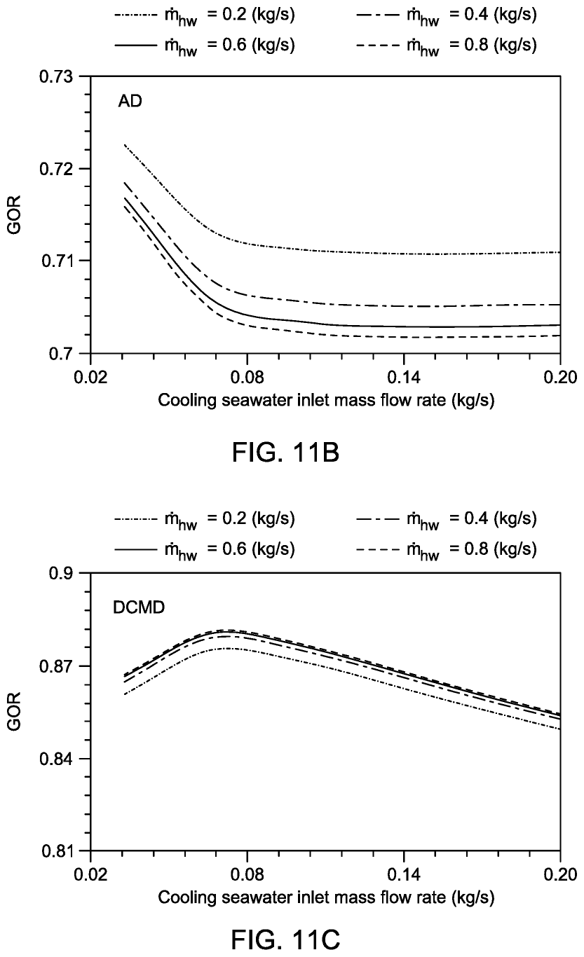

Further, it was observed that the GOR value of the DCMD module 102 increased with increasing re, before reaching its maximum value at re, of 0.08 kg/s; whereas the GOR value of the AD module decreased until reaching its minimum value at the same \dot{m}_{cw} (See FIG. 11B and FIG. 11C). The GOR values of the system 100 in FIG. 11A are slightly more than those in FIG. 7A by around 0.15, indicating the better performance of the second configuration (that is, the system 100 in FIG. 2). FIG. 10 and FIG. 11 indicates that the re, of 0.08 kg/s and \dot{m}_{hw} of 0.4 kg/s are the reasonable operational mass flow rates for optimal performance of the system 100.

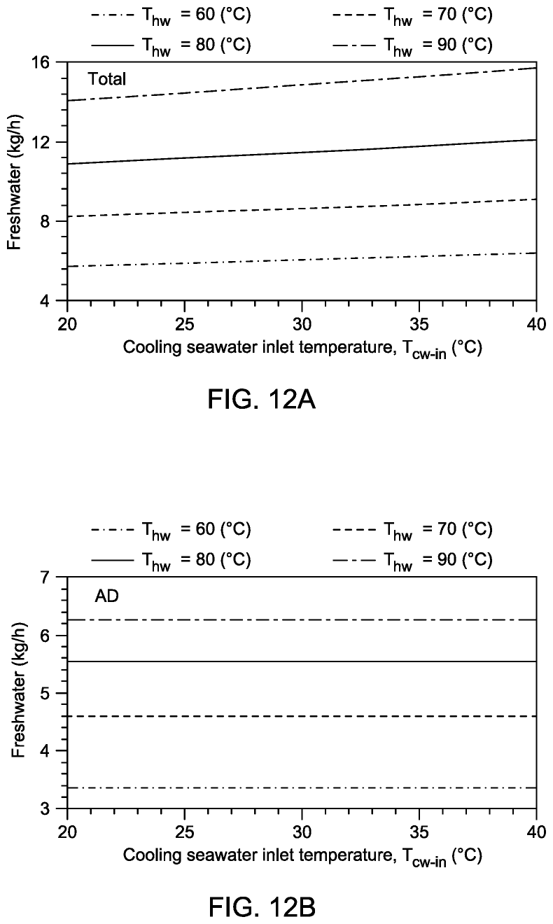

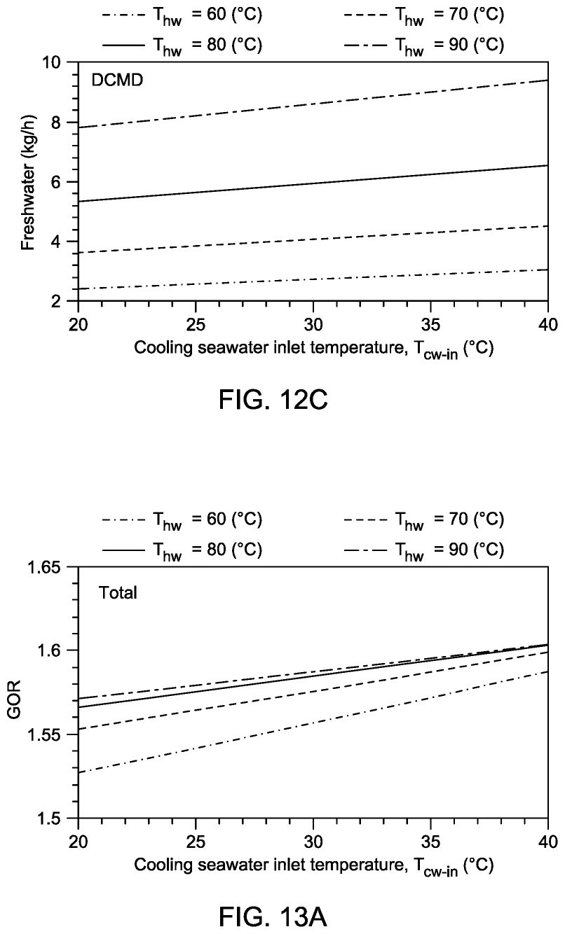

The temperatures of cooling water (T_{cw,in}) in the AD module (which feeds the DCMD module 102) and heating water (T_{hw,in}) also influences the freshwater production and GOR values of the second configuration of the system 100. At a fixed T_{hw,in}, the freshwater production of the AD module was almost constant when increasing T_{cw,in} from 20° C. to 40° C. (See FIG. 12B), while a different trend appeared in the first configuration of the system 100 where the freshwater production of the AD module decreased with increasing the temperature of seawater inlet to the condenser 114 (to feed DCMD module 102). Increasing the temperature of seawater input to the adsorber 120 (cooling water), which thus contributes to raising the feed temperature of the DCMD module 102, increased freshwater production of the DCMD module 102 at a constant heating water inlet temperature. Similar to the first configuration, the freshwater production of the AD module and the DCMD module 102 in the second configuration enhanced with increasing heating water inlet temperature. This is attributed to the higher heating water temperature, which resulted in a higher desorbed amount of water vapor in the AD module and hence more heat transferred to the DCMD feed stream passing through the adsorber 120.

FIG. 12A shows that the total freshwater production of the system 100 significantly increased with increasing the heating water temperature at a fixed cooling water inlet temperature. For example, when the heating water temperature increases from 60° C. to 90° C., produced freshwater from the system 100 increased by about 9 kg/h, which was much higher than the improvement that occurs in the first configuration under the same conditions.

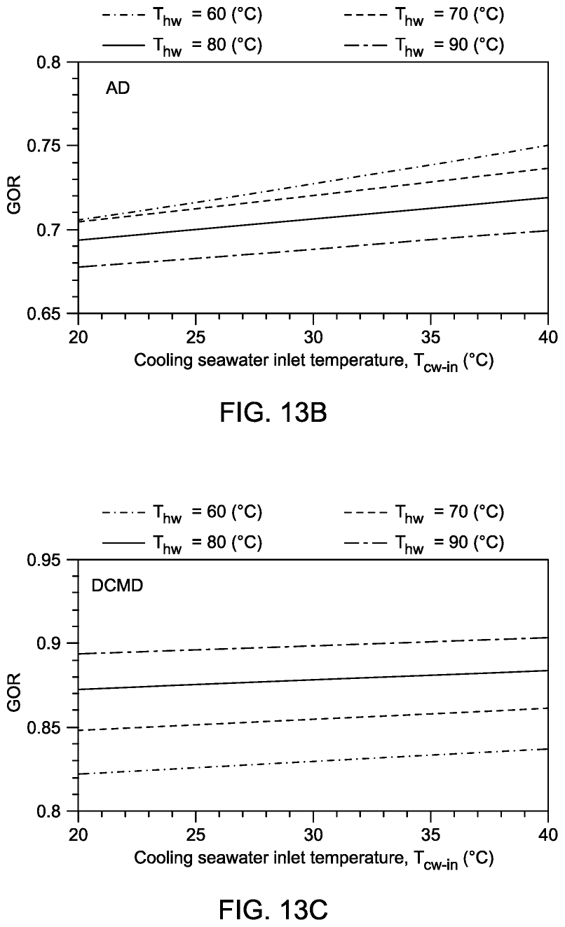

The GOR values of the second configuration of the system 100 were also investigated. FIG. 13B shows that the GOR of the AD module increased with raising the cooling water inlet temperature. For example, at T_{hw,in}=80° C., the GOR of the AD module increased from 0.69 to 0.72 when T_{cw,in} increased from 20° C. to 40° C., respectively. Moreover, significantly high GOR values for the DCMD module 102 were obtained with increasing T_{hw,in} and T_{cw,in}. FIG. 13C shows that the GOR values for the DCMD module 102 increased by almost 0.08 when T_{hw,in} increased from 60° C. to 90° C. at a fixed cooling water inlet temperature. Similarly, at T_{hw,in} of 80° C., the GOR values for the DCMD module 102 increased by almost 0.02 with increasing T_{cw,in} from 20° C. to 40° C. Due to the heat exchanged between the adsorbent (silica-gel) and seawater (DCMD feed) in the adsorber 120, higher DCMD feed temperatures and, therefore, higher GOR values for the DCMD module 102 were obtained. At optimal conditions, the total GOR values of the second configuration of the system 100 were greater than those reported in FIG. 9A (that is, for first configuration) by around 0.2. Based on the analysis of freshwater production and the GOR values for the second configuration of the system 100 at different heating water temperatures and cooling water temperatures, it was determined that the optimum performance occurred at T_{hw,in} and T_{cw,in} of 90° C. and 40° C., respectively. From an energy efficiency perspective, one may argue that the inlet temperature of 80° C. is a perfect choice for preheating because there is no significant difference between the total GOR values at T_{hw,in}=80° C. and T_{hw,in}=90° C. (See FIG. 13A).

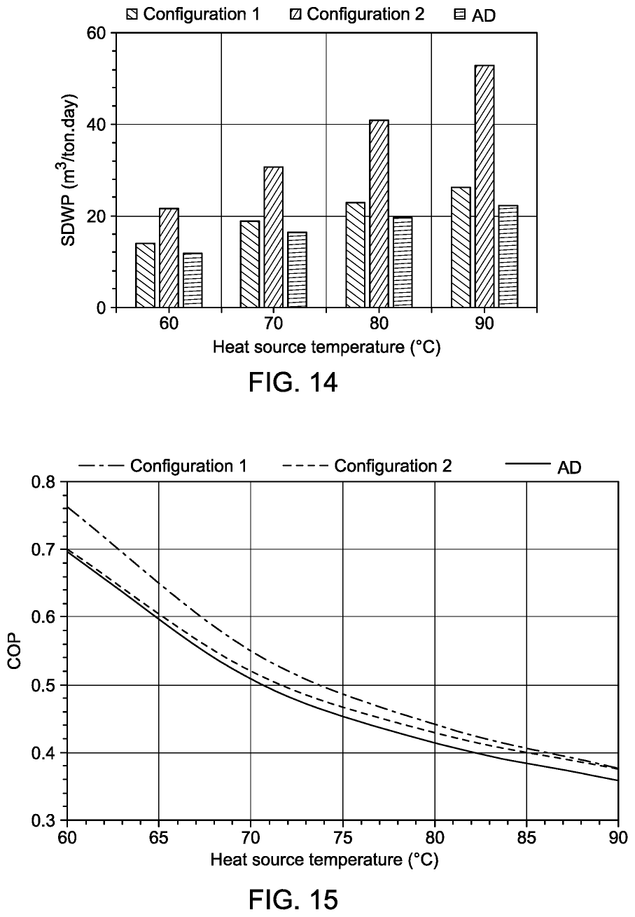

FIG. 14 illustrates a relationship between the freshwater production by the system 100 and the temperature of the heat source. For the first configuration and the second configuration, with an increase in the heat source temperature, an improvement in adsorption uptake occurred throughout the adsorption process, which in turn improved the water vapor desorption. Moreover, the temperature of the DCMD feed (seawater) was raised either by the waste heat inside the condenser 114 (as in the firs configuration) or inside the adsorber 120 (as in the second configuration). Therefore, a total freshwater production of the system 100 was enhanced. Overall freshwater production values (at T_{hw,in}=90° C.) was found to be 26 m³/ton·day and 53 m³/ton·day for the first configuration and the second configuration, respectively, which were both higher than that of a standalone AD module. The freshwater production of the second configuration was remarkably high, which can be attributed to its appropriate arrangement where the feed stream of the DCMD module 102 enters with a relatively higher temperature than that in the first configuration, resulting in a larger amount of freshwater. At a hot water temperature of 90° C., the first configuration and the second configuration produced higher water than the standalone AD module by 17.3% and 136.7%, respectively.

Both configurations of the system 100 generated a cooling effect as a by-product, which may be used for air conditioning. FIG. 15 illustrates a relationship between the COP of the system 100 and the heat source temperature. The COP of the first configuration and the second configuration were 0.76 and 0.7, respectively, at a heat source temperature of 60° C., which was higher than some standalone AD refrigeration systems (for example, see F. A. Lattieff, M. A. Atiya, J. M. Mahdi, H. S. Majdi, P. Talebizadehsardari, W. Yaici, Performance Analysis of a Solar Cooling System with Equal and Unequal Adsorption/Desorption Operating Time, Energies 2021, Vol. 14, Page 6749. 14 (2021) 6749) at similar operating conditions. The COP was noticed to decrease with increasing the heating source temperature, which is explained by Eq. 50. The heat removed in the evaporator 116 was constant, while increase in the heat source temperature increased the inlet heat of the AD module, hence decreasing the COP values. Compared to the AD module, the COP values of the integrated systems were higher.

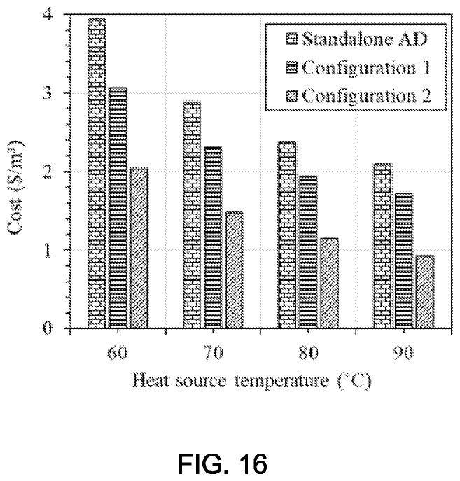

FIG. 16 illustrates graphs comparing the cost of freshwater produced for the optimal performance of the two configurations with the cost of freshwater produced by the standalone AD module. Freshwater costs of 1.72 and 0.92 ($/m³) for the first configuration and the second configuration, respectively, were obtained at a heat source temperature of 90° C. The freshwater cost of the first configuration and the second configuration was reduced by 18.03% and 56.05% compared to the AD module.

To this end, the present disclosure provides a hybrid DCMD-AD desalination system, such as the system 100. Two possible configurations of the system 100 were investigated. The first configuration couples and runs the DCMD module 102 with the AD condenser 114, whereas the second configuration drives the DCMD module 102 by the adsorption heat of the AD module. Experimentally validated models were employed to assess performance of the system 100. The GOR, freshwater production rate, SDWP, COP, and freshwater cost are the performance indices investigated for optimal values. For the first configuration and the second configuration, the GOR values reached 1.48 and 1.6, respectively. The enhancement in the GOR value was more than 117% for the system 100 compared to the standalone AD module. At a source temperature of 90° C., the freshwater production of the system 100 attained SDWP values of 26 m³/ton·day and 53 m³/ton·day for the first configuration and the second configuration, respectively. The second configuration produced freshwater by 136.7% higher than the standalone AD module. Moreover, each of the two configurations proved a capability of producing a cooling effect as a by-product, with COP values reaching 0.76 and 0.70 for the first configuration and the second configuration, respectively. Furthermore, the percent reduction in the freshwater cost produced by the second configuration (which reached 57.1%) demonstrated a significant improvement in the configuration's design. Therefore, the utilization of the DCMD module 102 as an auxiliary plant to endorse the AD module performance is doable and recommended by exploiting the AD adsorption heat to drive the DCMD module 102.

As used herein, the terms “a” and “an” and the like carry the meaning of “one or more.”

Numerous modifications and variations of the present invention are possible in light of the above teachings. It is, therefore, to be understood that, within the scope of the appended claims, the invention may be practiced otherwise than as specifically described herein.

1: An adsorption desalination direct contact membrane distillation (AD-DCMD) system, comprising:
a DCMD module including a hot compartment and cold compartment, wherein the hot compartment and the cold compartment are separated by a membrane, wherein the membrane permits water vapor to pass from a saltwater feed compartment to a water compartment, wherein the water compartment includes a DCMD condenser to condense the water vapor passing through the membrane;
a seawater tank in fluid communication with a condenser and configured to pass a seawater stream to the condenser via a seawater pump;
the seawater tank is in fluid communication with an evaporator and configured to pass the seawater stream to the evaporator via the seawater pump;
the condenser is in fluid communication with an adsorber and configured to pass a heated condensed seawater stream to the adsorber via a second valve; and
the condenser is in fluid communication with the hot compartment of the DCMD module and configured to pass the heated condensed seawater stream to the hot compartment of the DCMD module;
the condenser is in fluid communication with a desorber and configured to pass a heated desorbed seawater stream to the desorber via a fourth valve; wherein:
a hot water tank is in fluid communication with the desorber and configured to heat the heated desorbed seawater stream leaving a desorber outlet, and return the heated desorbed seawater stream leaving the desorber outlet to the desorber through a desorber inlet;
the adsorber is in fluid communication with the evaporator and configured to pass a cooled evaporated seawater stream to the evaporator via a first valve;
the desorber is in fluid communication with the evaporator and configured to pass a cooled evaporated seawater stream to the evaporator via a third valve;
the evaporator is in fluid communication with a brine tank and configured to pass a brine stream to the brine tank;
the condenser is in fluid communication with a freshwater tank and configured to pass a freshwater stream to the freshwater tank;
the cold compartment of the DCMD module is in fluid communication with a coolant tank and configured to pass a separated freshwater stream to the coolant tank, and the coolant tank is configured to return a separated saltwater stream to the cold compartment;
the coolant tank is in fluid communication with the freshwater tank and configured to pass the separated freshwater stream to the freshwater tank; and
the hot compartment of the DCMD module is in fluid communication with the brine tank by passing a separated brine stream to the brine tank.

2: The system of claim 1, wherein the adsorber and the desorber are housed conjoined within the same housing.

3: The system of claim 1, wherein the seawater tank is in direct fluid communication with the adsorber and the evaporator and is configured to pass the seawater stream to the adsorber and the evaporator respectively.

4: The system of claim 3, wherein the adsorber, the desorber, the condenser, and the evaporator are all housed within the same housing.

5: The system of claim 1, wherein the adsorber is in direct fluid communication with the hot compartment of the DCMD module and configured to pass an adsorber stream to the hot compartment of the DCMD module.

6: The system of claim 1, wherein the system comprises from 5 to 25 DCMD modules.

7: The system of claim 1, wherein the seawater pump is configured to pump a portion of the seawater stream to both the condenser and the evaporator.

8: The system of claim 3, wherein the seawater pump is configured to pump a portion of the seawater stream to both the adsorber and the evaporator.

9: The system of claim 1, wherein the seawater pump is an axial flow pump.

10: The system of claim 1, wherein the membrane is at least one selected from the group consisting of a composite membrane, a nano-composite membrane, a hydrophobic membrane, an omniphobic membrane, a hydrophilic and hydrophobic composite dual layer membrane, a modified ceramic membrane, a porous ceramic membrane, a surface modified membrane, a polymer electrolyte membrane, a porous graphene membrane, and a polymeric membrane.

11: The system of claim 6, wherein the DCMD modules are arranged in a counter-current configuration.

12: The system of claim 6, wherein the DCMD modules are arranged in a parallel/cross flow configuration.

13: The system of claim 6, wherein a first DCMD module outlet of a first DCMD module is in fluid communication with a second DCMD module inlet of a second DCMD module and configured to pass a DCMD stream from the first DCMD module outlet to the second DCMD module inlet.

14: The system of claim 13, wherein the first DCMD module outlet and the second DCMD module are disposed at the same height relative to a first membrane in the first DCMD module and a second membrane in the second DCMD module, respectively.

15: The system of claim 1, wherein the first valve, the second valve, the third valve, and the fourth valve are gate valves.

16: The system of claim 1, wherein the first valve and the fourth valve are parallel disc gate valves.

17: The system of claim 1, wherein the second valve and the third valve are solid-wedge gate valves.

18: The system of claim 14, wherein the first DCMD module is in fluid communication with the coolant tank and configured to pass a coolant tank stream from the coolant tank to the first DCMD module through a first DCMD module inlet.

19: The system of claim 14, wherein a terminal DCMD module is in fluid communication with the coolant tank and configured to return a terminal DCMD stream from the terminal DCMD module to the coolant tank through a terminal DCMD module outlet.
